(19) United States
(12) Patent Application Publication
(10) Pub. No.: US 2020/0405089 A1
(43) Pub. Date: Dec. 31, 2020

(54) SYSTEMS AND METHODS FOR SEPARATING AN EXTRACT FROM A SUSPENSION

(71) Applicants: Bruce A. Constantine, North Attleboro, MA (US); Christopher R McLean, Vancouver (CA)

(72) Inventors: Bruce A. Constantine, North Attleboro, MA (US); Christopher R McLean, Vancouver (CA)

(21) Appl. No.: 17/016,262

(22) Filed: Sep. 9, 2020

Related U.S. Application Data
(63) Continuation of application No. PCT/US19/21658, filed on Mar. 11, 2019.
(60) Provisional application No. 62/641,255, filed on Mar. 9, 2018.
(60) Provisional application No. 62/776,318, filed on Dec. 6, 2018.

(51) Int. Cl. A47J 31/02; A47J 31/46

(52) U.S. Cl. CPC A47J 31/02; A47J 31/461

(57) ABSTRACT

The present disclosure includes many embodiments of devices and related methods for creating an infused extract from a mixture of infusible material and one or more liquids. Any desired infusible material can be used, as well as any desired combination of liquids.

### CROSS-REFERENCE TO RELATED APPLICATIONS

The present application claims the benefit of priority to and is a continuation of International Patent Application No. PCT/US2019/21658, filed Mar. 11, 2019, which claims the benefit of priority to U.S. Provisional Patent Application No. 62/776,318, filed Dec. 6, 2018 and U.S. Provisional Application No. 62/641,255, filed Mar. 9, 2018. This patent application is also related to U.S. Design Application Ser. No. 29/639,985, filed Mar. 9, 2018, and U.S. Design Application Ser. No. 29/663,014, filed Sep. 11, 2018. Each of the foregoing patent applications is incorporated by reference herein in its entirety for any purpose whatsoever.

### FIELD

The present disclosure relates generally to apparati capable of carrying out an extraction of an infusible material and related methods, and more particularly to systems for extracting an infusion such as from coffee or tea.

### BACKGROUND

A main function of extraction systems (e.g., presses) is to ensure a separation between bulk infusible material such as coffee grinds and tea leaves, from an extract intended for consumption. While many different press and filter designs have been implemented, there is still room for improvement in achieving optimal separation. The present disclosure improves upon the state of the art.

### SUMMARY

Advantages of the present disclosure will be set forth in and become apparent from the description that follows. Additional advantages of the disclosure will be realized and attained by the methods and systems particularly pointed out in the written description and claims hereof, as well as from the appended drawings.

The present disclosure includes many embodiments of devices and related methods for creating an infused extract from a mixture of infusible material and one or more liquids. Any desired infusible material can be used, as well as any desired combination of liquids.

Thus, in some implementations, methods and devices for making an infused extract from at least one liquid and at least one infusible material is provided. An illustrative, non-limiting method can include providing an infusion apparatus including an infusing container, disposing at least one liquid in a reservoir of the infusing container, dispersing at least one infusible material in the liquid disposed in the reservoir in the infusing container to form a mixture and permitting the mixture to form an infused extract while in the reservoir of the infusing container.

In some implementations, the method can further include dispensing the infused extract from the reservoir of the infusing container. The infused extract can be dispensed from the reservoir of the infusing container into a second or receiving container. The second container can include an opening at an upper end of the second container for receiving a flow of infused extract from the infusing container. The opening of the second container can be small compared to a lateral dimension of the second container. The flow of infused extract originates from an exit in a lower end of the infusing container.

If desired, the method can include aligning the exit of the infusing container with the opening of the second container to permit the flow of infusible material to flow from the exit of the infusing container into the opening of the second container. The aligning step can include directing a conduit coupled to the infusing container into alignment with the opening of the second container. The aligning step can include positioning the opening of the second container directly beneath the exit of the infusing container to permit the flow of infused extract to fall into the opening of the second container. The aligning step can include placing at least one location on the second container into registration with the infusion apparatus. The at least one location on the second container can include at least one of (i) a top surface of the second container, (ii) a bottom surface of the second container, (iii) a side surface of the second container, (iv) a protuberance formed on an exterior or interior surface of the second container, (v) an indentation formed on an exterior or interior surface of the second container, (vi) indicia formed on the second container, (vii) a handle of the second container, (viii) a flange formed on the second container, and (ix) the opening of the second container.

If desired, the aligning step can include interposing an adapter between the infusing container and the second container to help facilitate alignment. If desired, the aligning step can include disposing the second container in a lower portion of the infusion apparatus. In some embodiments, the aligning step can include disposing the second container in a lower portion of a stand of the infusion apparatus. If desired, the dispensing step can be initiated by removing a plug. The dispensing step can be initiated by piercing a membrane. If desired, the dispensing step can be initiated by opening a valve. If desired, the valve can be opened as a separate act from aligning the infusing container with the receiving container. The valve can be opened as a result of aligning the infusing container with the receiving container.

In some embodiments, the valve can be opened while the infusing container is being moved along a vertical direction. The valve can be opened by rotating a portion of the infusing container. If desired, the valve can be opened by rotating a first portion of the infusing container with respect to a second portion of the infusing container.

The disclosure further includes methods of making an infused extract from at least one liquid and at least one infusible material using any of the disclosed embodiments.

The disclosure still further provides embodiments of an infusion apparatus for making an infused extract from at least one liquid and at least one infusible material. A non-limiting example of such an apparatus can include an infusing container to receive at least one liquid and at least one infusible material to form an infused extract.

If desired, the infusion apparatus can further include a drain for permitting the infused extract to drain from the infusing container. The infusion apparatus can include a receiving container to receive the infused extract by way of the drain of the infusing container. The second container can define an opening at an upper end thereof to receive a flow of infused extract from the infusing container. The opening of the second container can be small compared to a lateral dimension of the second container. The flow of infused extract can originate from an exit in a lower end of the infusing container. The exit of the infusing container can be configured and arranged to be aligned with the opening of the second container to permit the flow of infusible material to flow from the exit of the infusing container into the opening of the second container. The infusion apparatus can further include a conduit coupled to the infusing container to be directed into alignment with the opening of the second container.

It is to be understood that the foregoing general description and the following detailed description are illustrative and are intended to provide further explanation of the disclosed embodiments. The accompanying drawings, which are incorporated in and constitute part of this specification, are included to illustrate and provide a further understanding of the disclosed methods and systems. Together with the description, the drawings serve to explain principles of the disclosure.

### BRIEF DESCRIPTION OF THE DRAWINGS

The accompanying appendices, drawings, figures, images, etc. illustrate various example, non-limiting, inventive aspects, embodiments, and features (“e.g.,” or “example(s)”) in accordance with the present disclosure:

FIG. 1 is a schematic representation of a representative embodiment of system for forming an infused extract in accordance with the present disclosure.

FIG. 2A shows a first cross sectional view of an illustrative embodiment of an extraction system in accordance with the present disclosure.

FIG. 2B is a top view of the extraction system of FIG. 2A.

FIGS. 2C-2F illustrate top, central section, side plan, and top front perspective views of an embodiment of a further seal that can be used in various embodiments disclosed herein.

FIGS. 2G-2J illustrate top, central section, side plan, and top front perspective views of an embodiment of still a further seal that can be used in various embodiments disclosed herein.

FIGS. 2K-2N illustrate top, central section, side plan, and top front perspective views of an embodiment of yet a further seal that can be used in various embodiments disclosed herein.

FIGS. 2O-2R illustrate top, central section, side plan, and top front perspective views of an embodiment of still a further seal that can be used in various embodiments disclosed herein.

FIG. 3 shows a second cross sectional view of an extraction system in accordance with the present disclosure.

FIG. 4 is a top view of the extraction system of FIG. 3, showing the location of the cross section illustrated in FIG. 3

FIG. 5 is a side view of the extraction system.

FIG. 6 is a bottom view of the extraction system.

FIG. 7 is a first top isometric view of the extraction system.

FIG. 8 is a second top isometric view of the extraction system showing a filter insert.

FIG. 9 is a third top isometric view of the extraction system showing the filter insert removed.

FIG. 10 is a bottom isometric view of the extraction system.

FIG. 11 is a first exploded cross sectional view of the extraction system.

FIG. 12 is a top view of the extraction system showing the location of the cross section illustrated in FIG. 11.

FIG. 13 is a second exploded cross sectional view of the extraction system.

FIG. 14 is a top view of the extraction system showing the location of the cross section illustrated in FIG. 13.

FIG. 15 is a side exploded view of the extraction system.

FIG. 16 is a bottom view of the extraction system.

FIG. 17 is a top isometric exploded view of the extraction system.

FIG. 18 is a bottom isometric exploded view of the extraction system shown in duplicate.

FIG. 19 is a side view of the extraction system mounted on top of a container for capturing infused extract exiting from the extraction system.

FIG. 20 is a first cross sectional view of the arrangement of FIG. 19 taken along the cross sectional line A-A illustrated in FIG. 21.

FIG. 21 is a top view of the embodiment of FIG. 20.

FIG. 22 is a second cross sectional view of the arrangement of FIG. 19 that is angularly rotated with respect to the view in FIG. 20 along the line C-C illustrated in FIG. 4.

FIG. 23 is an isometric view of the arrangement of FIG. 19.

FIG. 24 is a side exploded view of the arrangement of FIG. 19

FIG. 25 is a cross-sectional exploded view taken along line A-A illustrated in FIG. 26.

FIG. 26 is a top view of the embodiment of FIG. 25

FIG. 27 is a cross-sectional exploded view taken along line C-C illustrated in FIG. 4.

FIG. 28 is a top exploded isometric view of the arrangement of FIG. 19

FIG. 29 shows two side by side bottom exploded views of the arrangement of FIG. 19.

FIG. 30A presents a cross sectional view of a further embodiment of a brewing apparatus in accordance with the present disclosure.

FIG. 30B presents an isometric cross sectional view of still a further embodiment of a brewing apparatus in accordance with the present disclosure.

FIGS. 30C-30D present an isometric cross sectional view and a cross sectional view of yet a further embodiment of a brewing apparatus in accordance with the present disclosure.

FIG. 30E is a cross sectional view of another embodiment of a brewing apparatus in accordance with the present disclosure with a valve in a closed condition.

FIG. 30F is a cross sectional view of the embodiment of the brewing apparatus of FIG. 30E with the valve in an open condition.

FIG. 31A is a cross-sectional view of a further embodiment of a brewing apparatus in accordance with the present disclosure.

FIG. 31B is a cross-sectional view of still a further embodiment of a brewing apparatus in accordance with the present disclosure.

FIG. 31C is a cross-sectional view of yet a further embodiment of a brewing apparatus in accordance with the present disclosure.

FIG. 31D is a cross-sectional view of yet a further embodiment of a brewing apparatus in accordance with the present disclosure that actuates flow by way of rupturing a membrane, such as filter paper or other material.

FIGS. 32A-C are views of a container including indicia for preparing an infused extract in accordance with the present disclosure.

FIG. 33 is an isometric view of a further embodiment of a brewing apparatus in accordance with the present disclosure with its optional cover removed to reveal details of its interior.

FIG. 34 is a side plan view of the embodiment of FIG. 33.

FIG. 35 is a top plan view of the embodiment of FIG. 33.

FIG. 36 is a top isometric view of the embodiment of FIG. 33.

FIG. 37 is a bottom plan view of the embodiment of FIG. 33.

FIG. 38 is a bottom isometric view of the embodiment of FIG. 33.

FIG. 39 is a side plan view of the embodiment of FIG. 33 coupled to a skirt and container in accordance with the present disclosure.

FIG. 40 is a bottom isometric view of the embodiment of FIG. 33 coupled to a skirt and container in accordance with the present disclosure.

FIG. 41 is an isometric view of a further embodiment of a brewing apparatus in accordance with the present disclosure with its optional cover in place.

FIG. 42 is a top plan view of the embodiment of FIG. 41.

FIG. 43 is a side plan view of the embodiment of FIG. 41.

FIG. 44 is a bottom plan view of the embodiment of FIG. 41.

FIG. 45 is an exploded cross sectional view of a further embodiment of a brewing apparatus in accordance with the present disclosure.

### DESCRIPTION

Reference will now be made in detail to the present preferred embodiments of the disclosure, examples of which are illustrated in the accompanying drawings. The methods and corresponding steps of the disclosed embodiments will be described in conjunction with the detailed description of the disclosed devices.

Various embodiments are provided herein of an extract separation apparatus that are useful for separating an infused extract from a mixture of an infusible material and the extract.

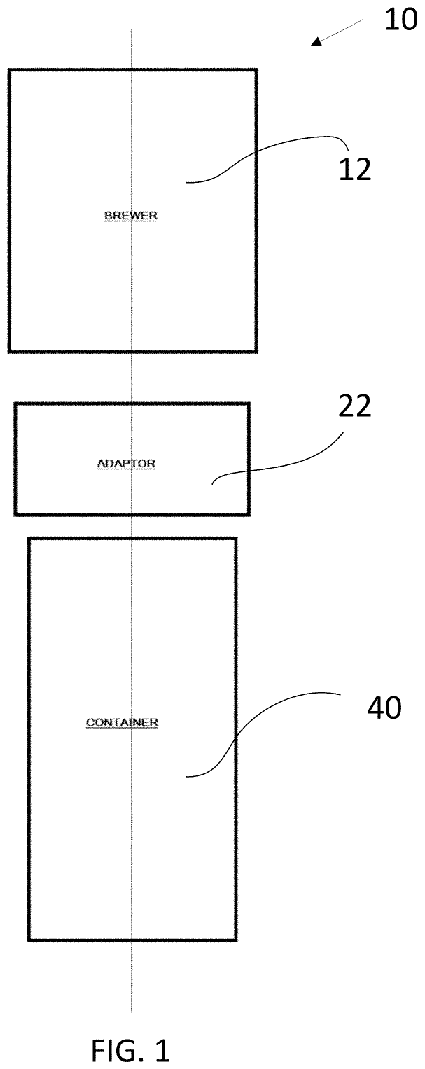

FIG. 1 is a schematic illustration of a representative embodiment of a system and related method in accordance with the disclosure. System 10 includes three illustrated components, including an infusion container 12, an adaptor 22, and a second container 40, although it will be appreciated that this illustration can include additional or fewer individual physical components. For example, if an adaptor is provided, it can be presented as a separate component, or it can be integrated into components 12 and/or 40. The components are illustrated as a block diagram because the particular configurations of each of the components 12, 22, 40 can include any of the embodiments herein (discussed below), as the disclosed embodiments are configured to achieve a mechanical adaptation and alignment between an infusion container, and a second container for receiving infused extract from the infusing container. The adaptor 22 can be configured to align and fit disparate infusing containers and additional containers to facilitate formation and dispensing of infused extracts. Any of the infusing containers disclosed herein can be used, as well as infusing containers known in the art.

Any desired second or receiving container can be used, such as growlers, thermoses, flasks, beakers, cups, mugs, and the like. In some embodiments, the receiving container can be made from a transparent, translucent, and/or opaque material. The material of the receiving container itself can include a glass, a polymer, a ceramic, and/or a metal, for example. If at least partially transparent or translucent, the transparent or translucent portion of the container can be spectrally selective such that it transmits certain wavelengths of light and tends to obscure (e.g., reflect or absorb) other wavelengths of light. For example, it some implementations it can be preferable to use brown glass for the receiving container. The brown glass material can have a L* transmittance value (in accordance with CIE L*a*b* color space), as measured on a standardly calibrated Hunterlab spectrophotometer, between being opaque (L*=0) to an L* of about 95, or any increment therebetween of about one L* value (e.g., 1, 2, 3, 4, . . . 40, 41, 42, 43, . . . 60, 61, 62, etc.). To ensure consistency, the spectrophotometer should be properly calibrated as instructed by Hunterlab. In this implementation, the sample, whether glass or polymeric, should be about 3 mm thick, and formed into the shape of a flat plaque (e.g., 3×5 inches), be essentially haze free or have very low haze, and have a smooth surface finish consistent with SPI/SPE A1, A2, or A3 such that the L* transmittance measurement is indicative of the properties of the material itself, rather than the result of imperfections in the formation process that could result from a rough surface finish or improper melting and freezing. The sample can have an a* value and a b* value between 10 and −10, or any incremental value therebetween of 0.1. In some implementations, the color coordinates are consistent with various shades of brown, and L*, as set forth above, is relatively low (e.g., 40-65) but still able to transmit some visible light. If made from a PET material, the PET material is preferably a slow-crystallizing resin having a low (e.g., less than 100 ppm) or no antimony content and be formed using a non-antimony catalyst, such as those described in U.S. Pat. Nos. 7,129,317, 8,431,202 and/or 8,524,343 each of which hereby being incorporated by reference in its entirety for any purpose whatsoever. Alternatively, the underlying polymer can have a primary antimony poly-condensation catalyst system that is otherwise suitable for “hot fill” applications. The receiving container can have different volumes, such as between about 50 ml and 5000 ml, or any increment therebetween of 5 ml. The receiving container can be reusable or disposable, as desired. The receiving container can have any desired shape, including at least partially cylindrical, or can have a horizontal cross section along at least a part of its length that is rectangular (e.g., square), pentagonal, hexagonal, or the like. The receiving container can be provided with a flat base, an indented base, or a petaloid base (having one or more bosses, 3, 5, 7, etc.), for example, that aligns/interdigitates with one or more indentations or bosses of the cold brewing system. The receiving container in some embodiments can include a re-sealable or re-closable bag, pouch, or other flexible container that is opaque or translucent or transparent. In another embodiment, the receiving container is a travel cup or travel mug that can include an enhanced thermal mass, wherein the travel cup can be placed in a freezer prior to or after use so as to avoid the need for ice in a resulting drink to keep it cool.

The adaptor 22 is configured to help achieve alignment of the infusing container and the receiving container. Alignment can be achieved by maintaining registration of a portion of the infusing container 12 with a portion of the adaptor 22, and by maintaining registration of a portion of the adaptor 22 with the receiving container. In some embodiments, the adaptor 22 can include a funnel that is configured to receive a fluid stream exiting the infusing container 12 and direct it to the receiving container 40. Registration, and thus alignment, can be obtained, for example, by aligning respective markings or other indicia on each component, by fitting cooperating shapes of each respective component, or, in another embodiment, placing one component at least partially inside of another component.

In accordance with some embodiments, the apparatus can include an open top infusing container adapted to contain the mixture, and having one or more substantially vertical walls oriented substantially parallel to a vertical axis of the container.

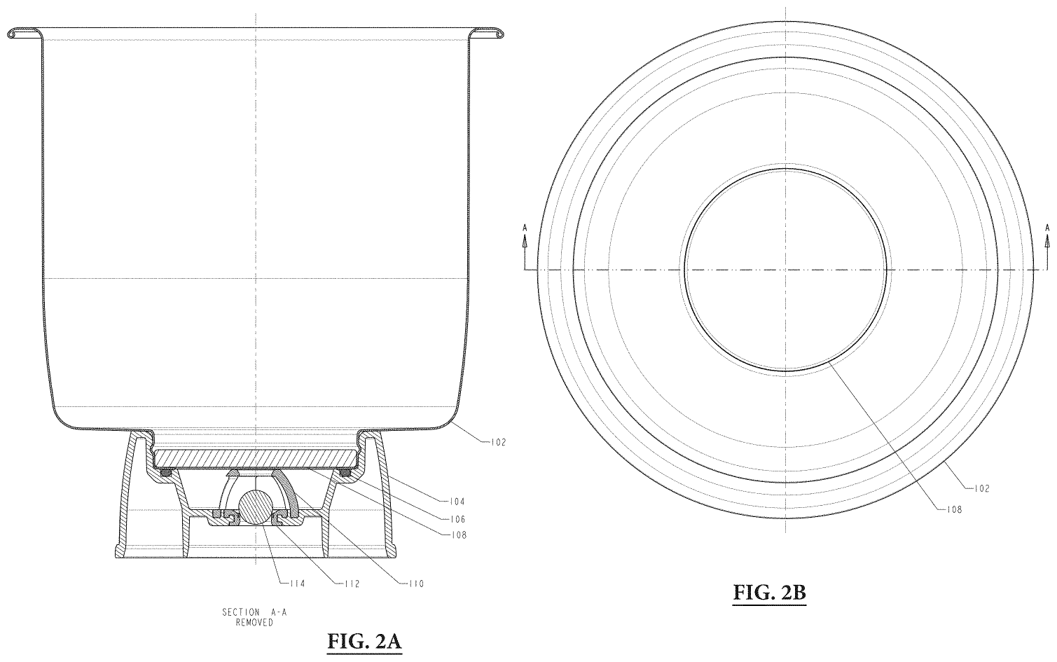

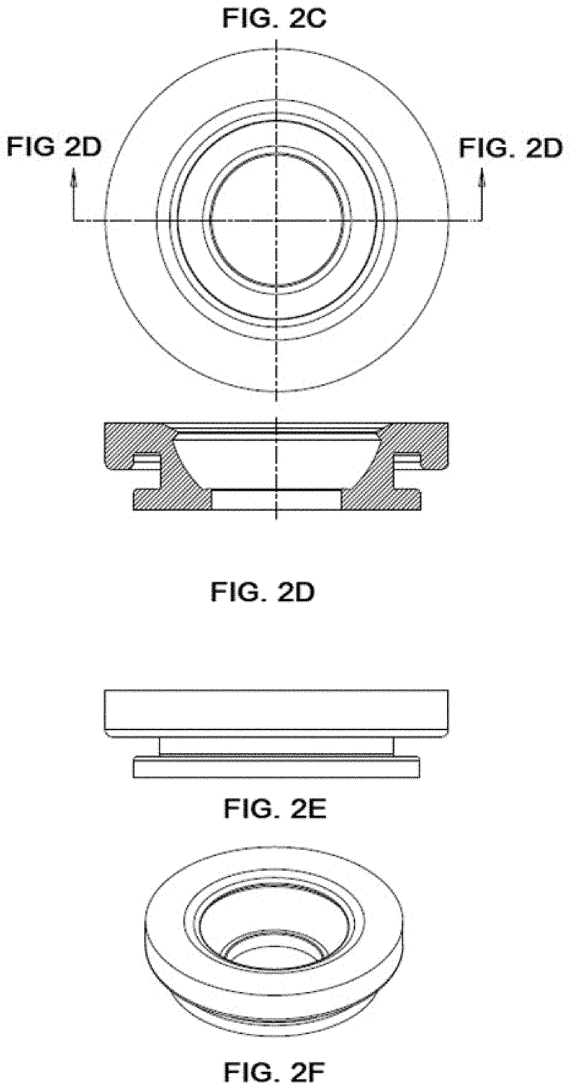

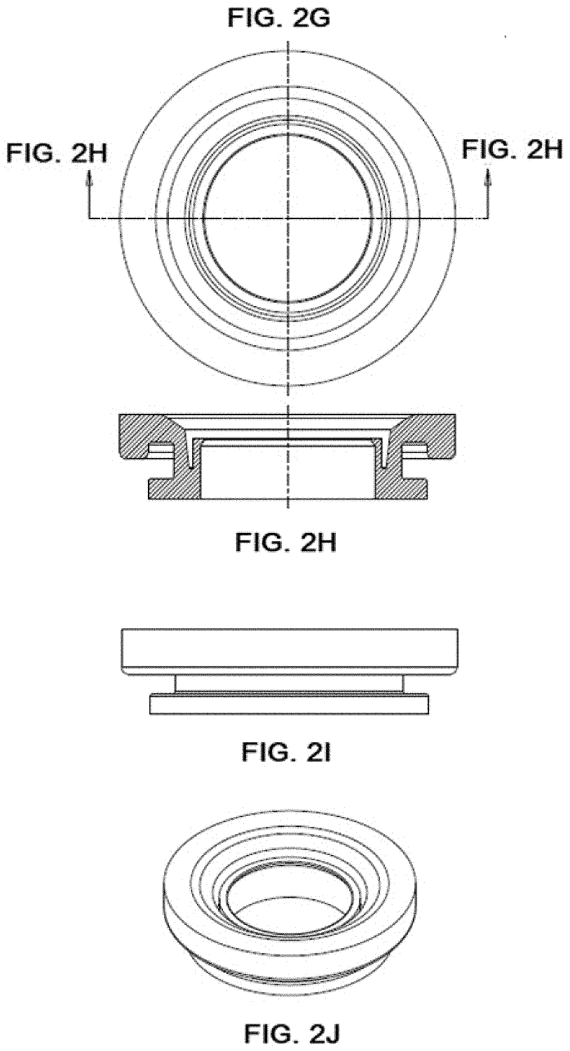

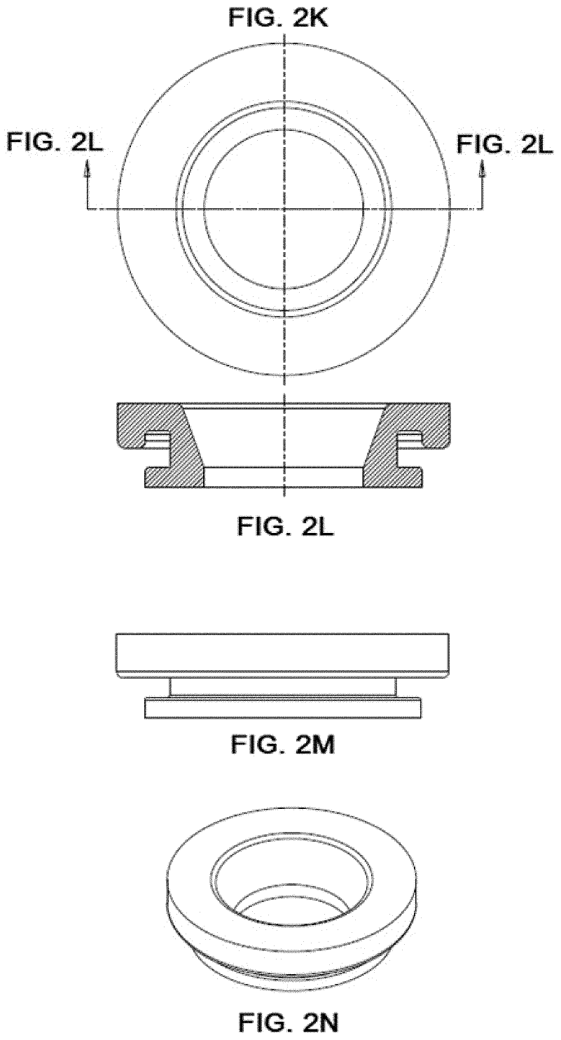

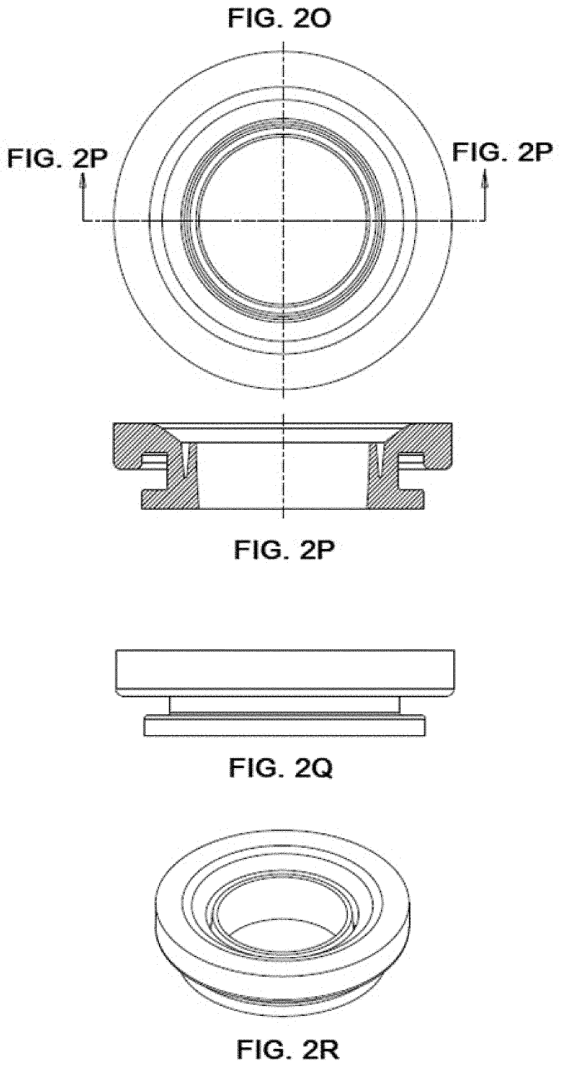

For purposes of illustration, and not limitation, FIG. 2A shows a first cross sectional view of an extraction system in accordance with the present disclosure taken along line A-A, in this case the vertical centerline, in FIG. 2B. FIG. 2B is a top view of the extraction system of FIG. 2A.

As illustrated, an open top infusing container 102 is provided that is shaped substantially like an inverted bell. Container 102 is preferably generally cylindrical in shape, but may be any other suitable shape, such as one having a horizontal cross sectional shape of a rectangle, square, a polygon with three or more sides such as a triangle, pentagon, hexagon, octagon, and the like. The overall shape of the container 102, while illustrated as being generally bell-shaped can alternatively be funnel shaped, conical in shape, pyramidal, and the like. Preferably, container 102 is symmetrical about a central vertical axis to some extent, or weighted evenly about the central vertical axis to prevent risk of tipping. Container 102 as well as containers in any other embodiment herein can have any desired aspect ratio of height to width, such as but not limited to 1:1, 1:1.5, 1:2, 1:2.5, 2:1, 2.5:1, 0.75:1, 0.5:1, and the like, as desired.

FIG. 2A also illustrates an opposing base 104 that is illustrated as being annularly shaped and also bell shaped on its exterior. As with container 102, base 104 can have any shape as recited with respect to container, and may additionally be provided as a framework, a mesh, a plurality of legs connected to a ring or freely floating, and the like. Base 104 can snap fit to or is otherwise attached to container 102, such as by way of adhesive, interference fit, by way of fasteners, or by way of a threaded connection, as discussed in further detail below. Alternatively, base and container can be integrally formed and molded or otherwise formed as a single piece, also discussed in further detail below.

A seal 106 can be provided to prevent or substantially prevent fluid from passing underneath filter 108. Seal 106 can be any suitable mechanical seal such as an o-ring as illustrated, or any other suitable seal material or mechanical structure, such as a ridge, that impinges on filter 108 to reduce or eliminate flow around the filter 108. Seal 106 is illustrated as being trapped between container 102 and base 104. Seal 106 is depicted as being received by an annular recess formed into an upper surface of base 104.

A disc shaped filter 108 is mechanically retained within a reduced diameter bottom annular section of container 102. Filter 108 can be mechanically retained in any desired manner, such as an interference fit, with an additional retainer, and the like.

Filter 108 can be, for example, a die cut woven or nonwoven material, made, for example, from polyester or natural fibers, such as wool, cotton, and/or other fibers. In additional embodiments, the filter can be a mesh, screen, or perforated material made from metal, plastic or composite material. The filter 108 can also be any desired shape.

Moreover, filter 108 can be formed from two or more components, if desired, such as two or more layers of different disposable or reusable materials to provide a gradient in filtration. For example, an upper surface or layer of filter 108 can be configured to trap large particles of infusible material (e.g., coffee grounds, tea leaves, whole or cut fruit, fruit rind or zest, botanical materials, and the like), and lower layer(s) of the filter 108 can be configured to trap progressively finer particles of the respective infusible material. For example, filter 108 can be formed from a plurality of stages of progressively finer screen or mesh materials. Filter 108 can be unitary in this instance, or can be configured to be disassembled for cleaning. In addition, the device can be provided with a plurality of different filter elements that can be used as the filter, or that can be selectively combined to form a customized filter that is complementary to the size of infusible material from which an extract is formed. Moreover, filter 108 can be formed from a combination of materials such as a mesh and nonwoven material, or a mesh. Additionally, a disposable paper filter (not shown) can be provided that conforms to the shape of the container 102. Such a paper filter can be used in addition to or in lieu of a filter element 108.

While the filter 108 is depicted as being circular, the filter 108 and the opening that receives it may be circular, a polygon having one or more straight and/or curved edges, elliptical, and the like. The shape of the filter 108 need not match the shape of its opening exactly. For example, the opening may be circular and the filter may be a polygon, wherein apices of the polygon are compressed when the filter is inserted into the opening. Alternatively, the opening could be a polygon, such as a hexagon, and the filter can be circular or elliptical, wherein an interference fit is achieved by deforming a part of the filter media. The filter 108 has a thickness suitable to perform its operation. Where the filter 108 is a compressible disposable material, the filter 108 can be between, for example, about 0.5 mm and 1.5 cm, or any thickness therebetween in increments of about 0.5 mm.

As illustrated in the figures, container 102 includes a lower annular wall that then turns radially inward to form a circumferential shelf that supports filter 108 in part. It will be appreciated that the filter 108 can likewise be suspended over a framework or mesh structure and that a peripheral ridge is not needed. As further illustrated, said lower annular wall that extends below the bowl portion of container 102 defines an outwardly projecting annular rib that is in turn received by an annular groove formed into an inwardly facing annular wall defined near the top of base 104. Alternatively, rather than an interference fit, the connection between components 102 and 104 can be a different type of mechanical connection, such as a threaded connection, or a connection with fasteners to permit disassembly and cleaning of the components. Any other desired type of connection can be used to connect components 102 and 104, such as adhesives, hook and loop fasteners, or a connection that includes one or more magnets within component 102 and/or 104 that attracts a respective aligned portion of the opposing component 102/104 that includes another magnet and/or ferromagnetic material.

As further illustrated in FIG. 2A, a valve assembly is provided that selectively permits fluid to pass through it into a container, for example. In the example illustrated in FIG. 1, a spherical ball valve body 114 is received in a compliant annular seal 112. Seal 112 in turn is seated and surrounds an annular boss formed in a lower central portion of base 104. An open framework 110 is situated over ball 114 to prevent ball 114 from escaping. Framework 110 can be ultrasonically welded to base 104 or otherwise attached to base 104.

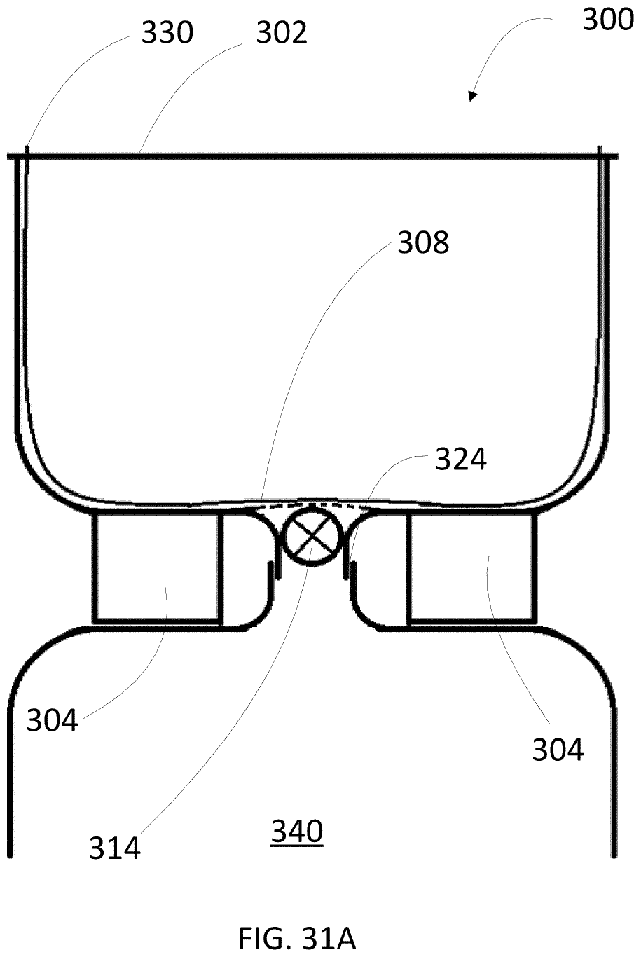

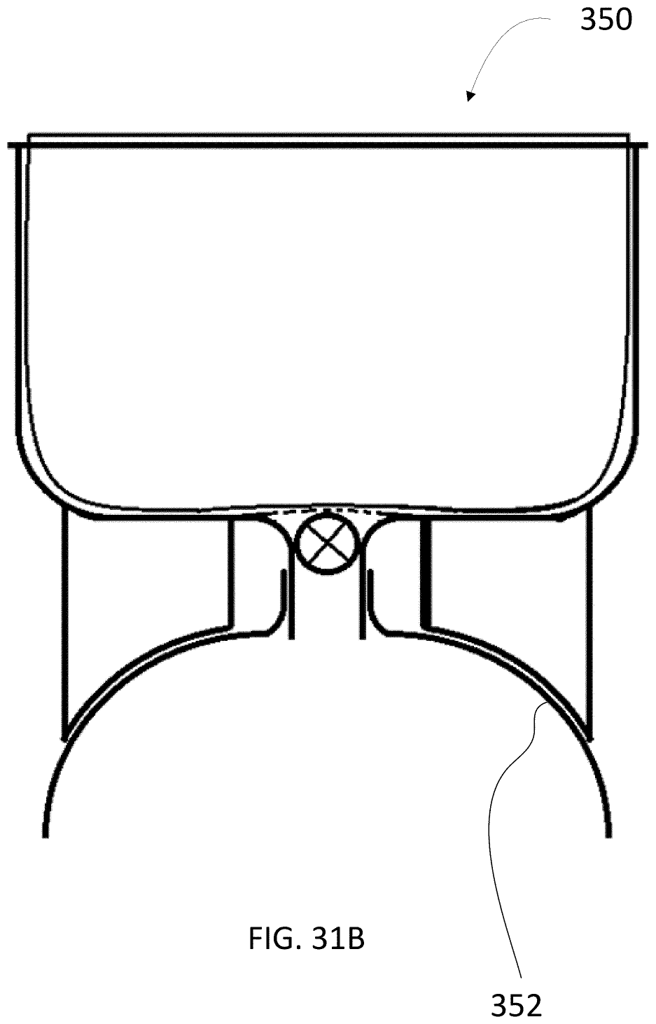

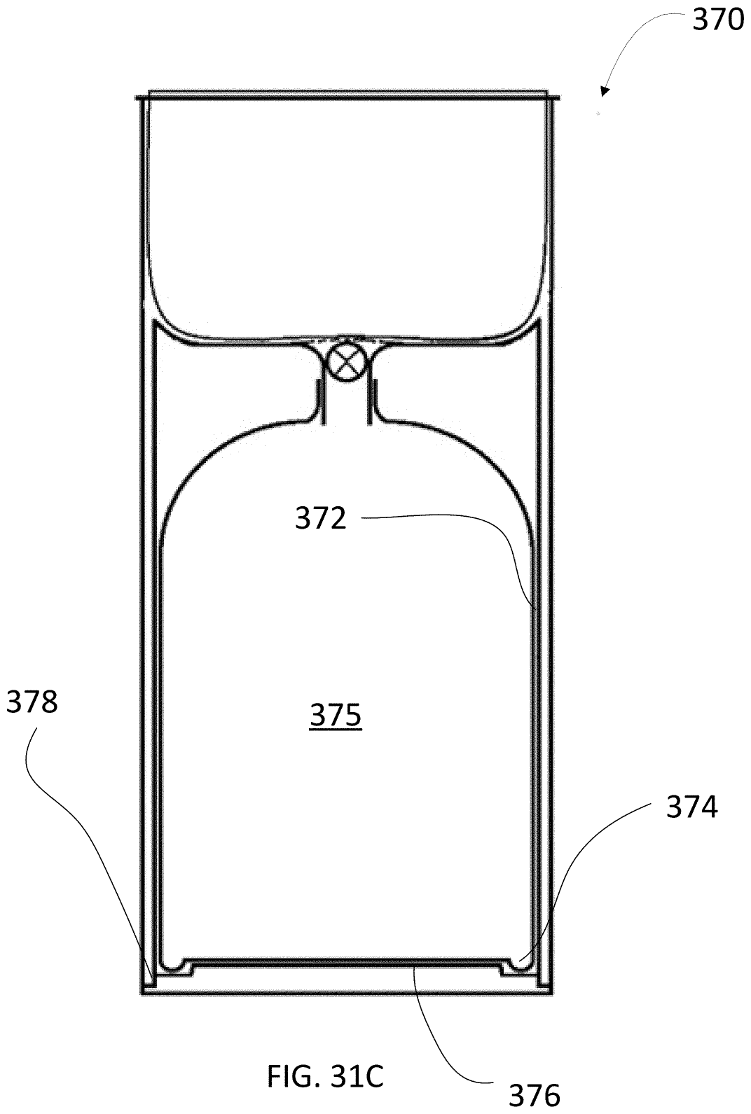

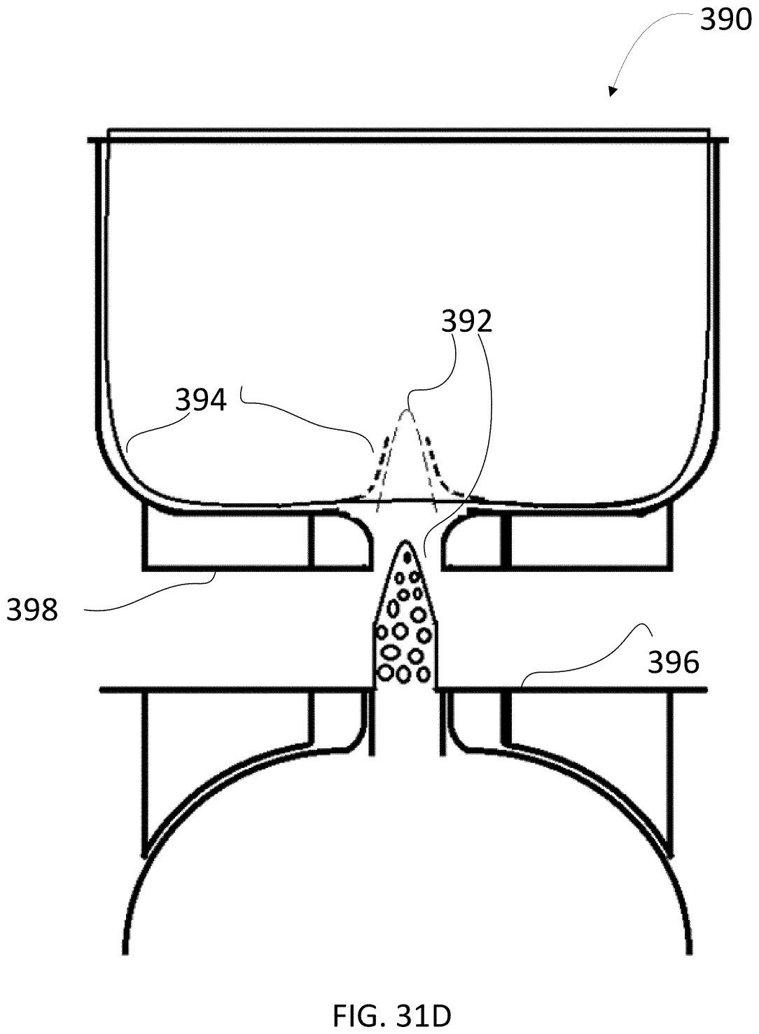

A variety of alternative mechanisms can be used in place with, or in addition to, the valve assembly illustrated in FIG. 2A and discussed above. For example, as discussed below, a compression spring can be used to hold the ball valve in place. Moreover, any kind of valve can be used, such as a globe valve, ball valve, plug valve, pinch valve, gate valve, and the like (not shown) that is actuated by rotating a valve body located in a seat about an axis that is generally perpendicular to the vertical central axis of the container 102. The ball 114 of the valve assembly can similarly be a displaceable piston or other structure other than a sphere that is displaced upwardly, downwardly or laterally to open the valve when it is actuated. For example, the valve assembly can simply include a flap made from resilient material that is displaced in order to permit flow out of the container. If desired, a drain plug can be provided that can be removed from the reservoir of the infusing container, or from a flow passage in the infusing container, to permit liquid to flow out of the infusing container. For example, a drain plug can be pulled downwardly out of a bottom of the infusing container, or laterally out of a side of the infusing container. If desired, a valve can be used that ruptures a frangible membrane (e.g., filter paper), such as that illustrated in FIG. 31D. The valves can be located toward or at the center of a bottom of the infusing container 102, or may be located off center, on a wall, and the like. Moreover, such valve options, assuming a valve is included, can be applied to any other embodiment disclosed herein.

Seal 112 can similarly have a variety of alternative geometries as set forth in FIGS. 2C-2R.

For example, FIGS. 2C-2F illustrate top, central section, side plan, and top front perspective views of an embodiment of a further seal that can be used in various embodiments disclosed herein. The cross sectional view in FIG. 2D illustrates the geometry of the seal structure, wherein, as illustrated, all of the depicted seals in FIGS. 2C-2R share similar external features to help the seal seat in the structure of the apparatus, including a relatively flat upper annular surface that transitions into a generally vertical annular surface that terminates in a downwardly depending annular flange. The downwardly depending flange transitions into an upwardly traversing surface that helps to define an annular recess disposed radially inwardly from the downwardly depending flange. The annular recess is defined by an outer annular wall that extends upwardly from the downwardly depending flange, an upper generally horizontally directed annular wall that is generally orthogonal with respect to the outer annular wall, and an inner annular wall that extends downwardly from the upper annular wall. At its lower extremity, the inner annular wall transitions into a radially outwardly directed shoulder that is formed from a radially outwardly extending horizontal annular surface that then transitions downwardly by about 90 degrees, and terminates at a lower annular surface of the seal. The general differences in the illustrated seals in FIGS. 2C-2R can be found in the inner cavity that is defined between the upper and lower surfaces of the seal. The external geometry of the seals can be modified as appropriate in order to fit different structures, as desired.

With respect to FIG. 2D, an inner cavity is defined by the structure of the seal that begins at the upper annular surface of the seal, and tapers radially inwardly and downwardly along about a 30-40 degree angle from horizontal terminating at a peripheral edge. The inner surface of the seal then transitions radially outwardly from the peripheral edge at about a 135 degree angle with respect to the horizontal and terminates at an inner corner, such that the peripheral edge forms a lip that can seat the ball portion of the valve, or other valve body, as desired. The seal material can be relatively stiff, or relatively compliant to facilitate sealing of the valve, depending on the material of the valve body, whether a spring is included, and the like. The inner surface of the seal continues downwardly from the inner corner, and sweeps radially inwardly along a curved path until it turns radially inwardly and then downwardly to form a shoulder. The inner surface then continues downwardly to the lower face of the seal. The seals described herein and the valve bodies disclosed herein can, for example, be made from a variety of materials, including various types of metals, various composite materials, ceramics, and plastics (e.g., ABS, PET, polyurethane, acrylic, polypropylene, elastomers, vinyl materials, polyolefins, rubber, NYLON polymers, fluoropolymers, and the like).

FIG. 2H illustrates a seal structure with a different inner opening than that of FIG. 2D. The inner opening begins at the upper surface of the seal and extends downwardly along a shallow angle (e.g., 30-50 degrees from horizontal) at which point it transitions and extends downwardly at a considerably steeper angle (e.g., 60-90 degrees from horizontal where it terminates at a lower inflection point, and then rises again to form an annular trough. The inner surface then traverses along a radially inward direction, and then angles downwardly and radially outwardly at about a 135 degree angle from horizontal to form a lip, and then transitions downwardly to form a generally vertical wall until it reaches the bottom face of the seal. A radially outward facing wall of the annular trough and an inwardly facing wall of the inner surface cooperate to form an annular wall structure that terminates at an upper end at the aforementioned lip that is configured to receive at least a portion of the valve body. The material of the seal can be selected to achieve a desired amount of compliance to help seat the valve body.

FIG. 2L provides a seal with a relatively simple geometry having a central bore with an inner annular surface that begins at the upper surface of the seal, curves radially inwardly and downwardly at a fillet, and then extends downwardly at a relatively steep (e.g., 50-75 degree) angle, and then transitions downwardly at a peripheral ridge for seating the valve body to form a generally vertical annular wall that intersects the lower surface of the seal.

FIG. 2P presents a variant of the seal that generally resembles the geometry of FIG. 2H, but that omits the radially inwardly directed lip at the upper periphery of the upwardly extending annular wall that is defined within the bore of the seal. It will be appreciated that not all of the illustrated surfaces of the seals need to be provided in the precisely illustrated geometry, but that any structures that are similar and perform similar functions are also contemplated.

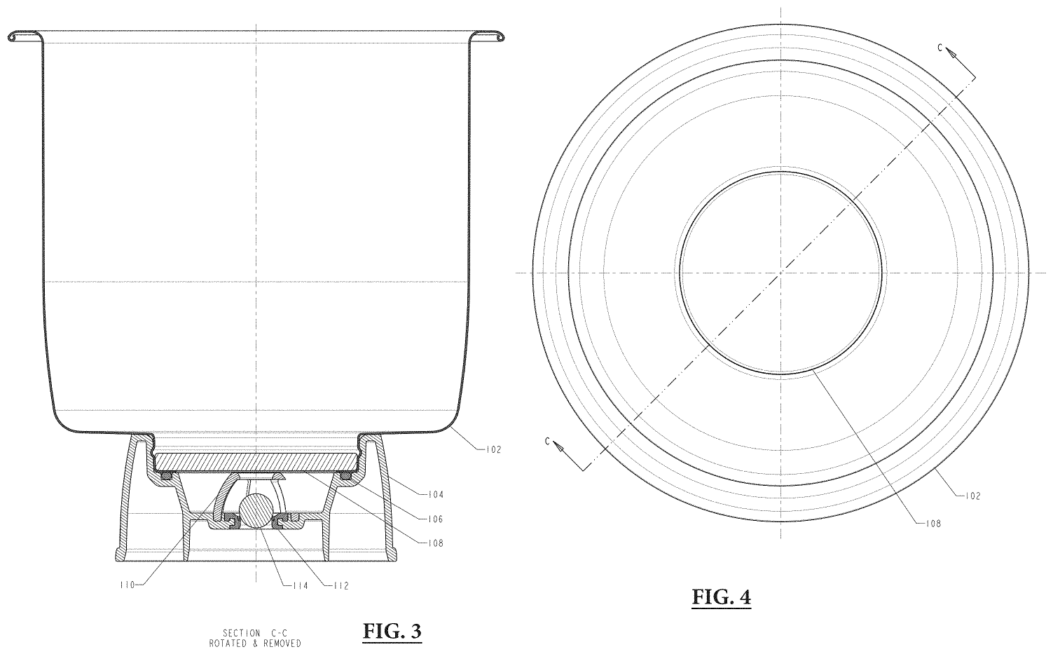

FIG. 3 shows a second cross sectional view of an extraction system in accordance with the present disclosure. This alternative view is taken along line C-C in FIG. 4. This alternative view shows, in FIG. 3, a different rotational position of the assembly about the central vertical axis of container 102, particularly notable in the alternative rotational position of framework 110, illustrating an opening on the right side of framework through which infused extract may flow. It will be appreciated that the framework 110 could instead take the form of a cup shaped screen material, and the like.

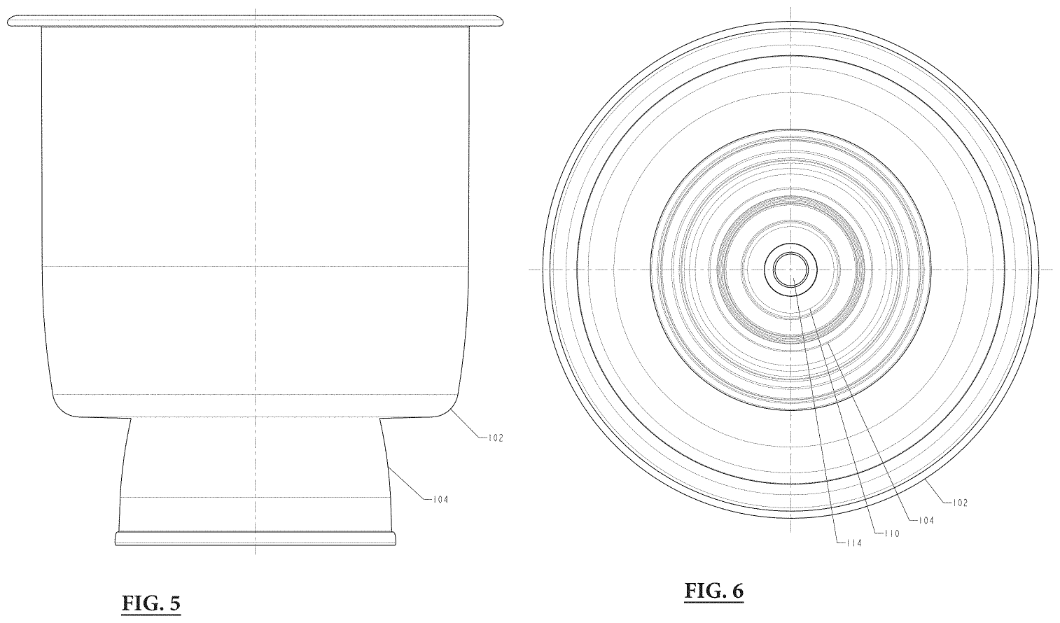

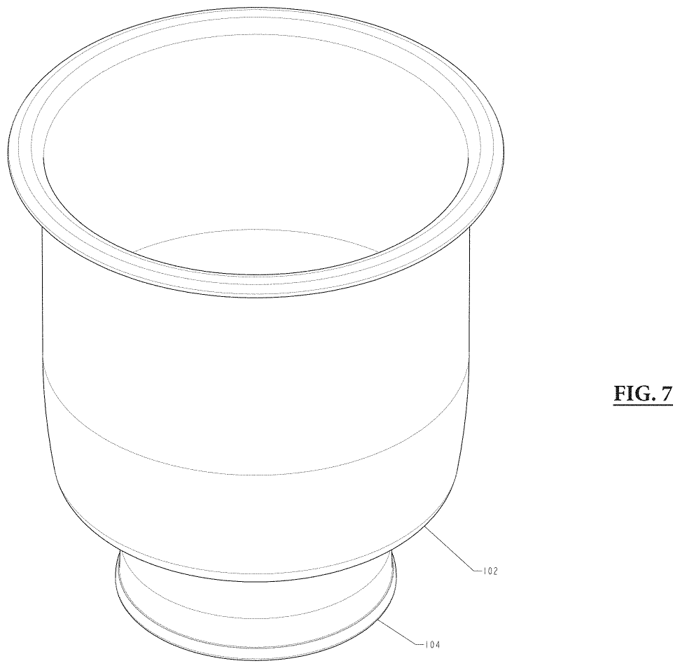

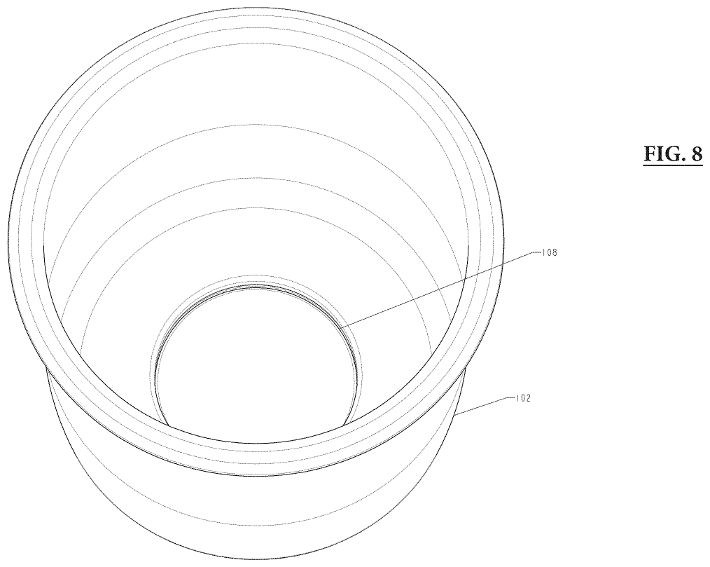

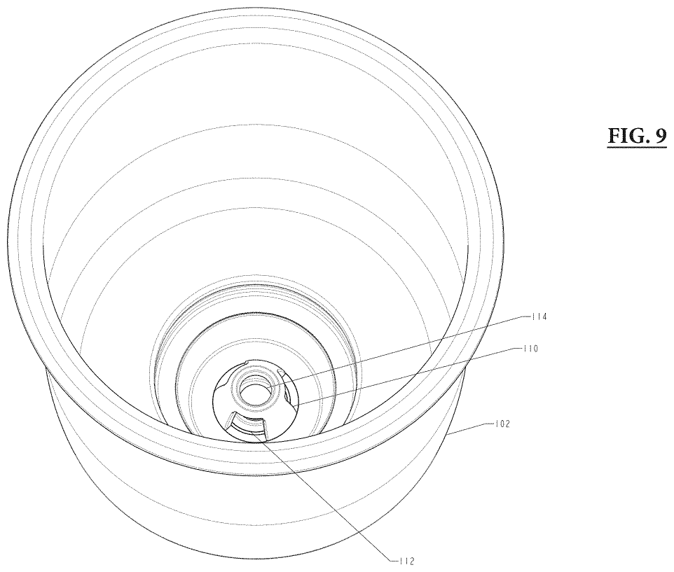

FIG. 5 is a side view of the extraction system illustrating relative placement of container 102 and base 104. FIG. 6 is a bottom view of the extraction system particularly illustrating the relative radial placement of container 102, base 104, frame 110, and ball 114. FIG. 7 is a first top isometric view of the extraction system, also illustrating relative placement of container 102 and base 104.

FIG. 8 is a second top isometric view of the extraction system showing a filter insert 108. In addition to filter 108, a separate paper filter can be placed in the container 102 to filter extract from a mixture, for example, of coffee grounds and water, or tea leaves and water, as desired.

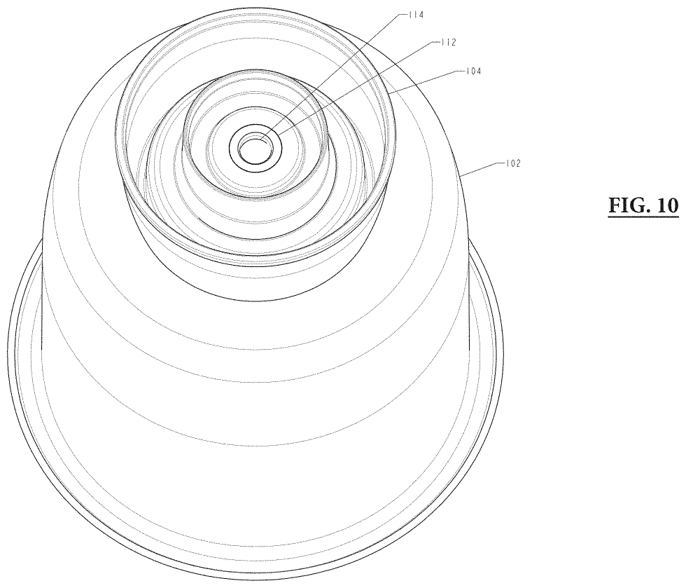

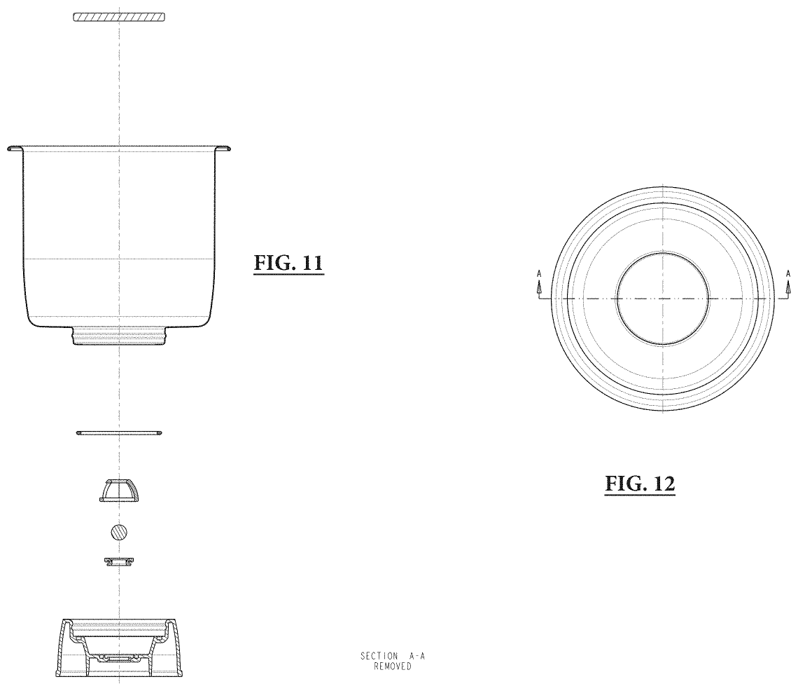

FIG. 9 is a third top isometric view of the extraction system showing the filter insert removed. Removal of filter 108 clearly illustrates the relative placement of framework 110, which is formed by an upper ring and three evenly spaced struts that are in turn attached to a lower ring that is in turn attached to base 104 to contain ball valve body 114 (or alternative valve structure, as desired). FIG. 10 is a bottom isometric view of the extraction system that further illustrates the spatial relationship of seal 112, ball valve body 114, base 104 and body 102.

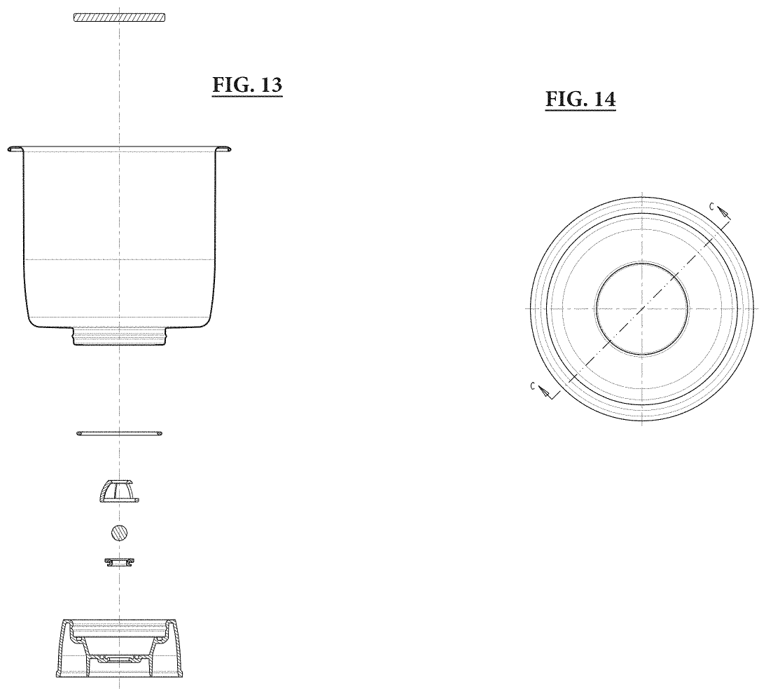

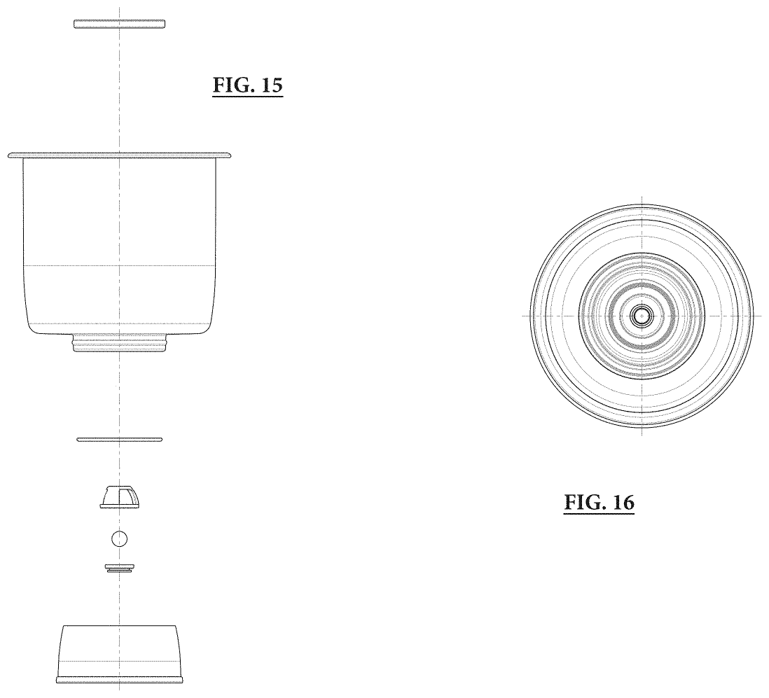

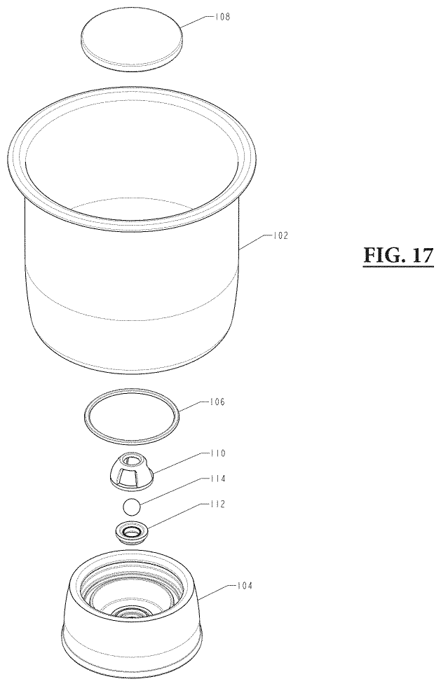

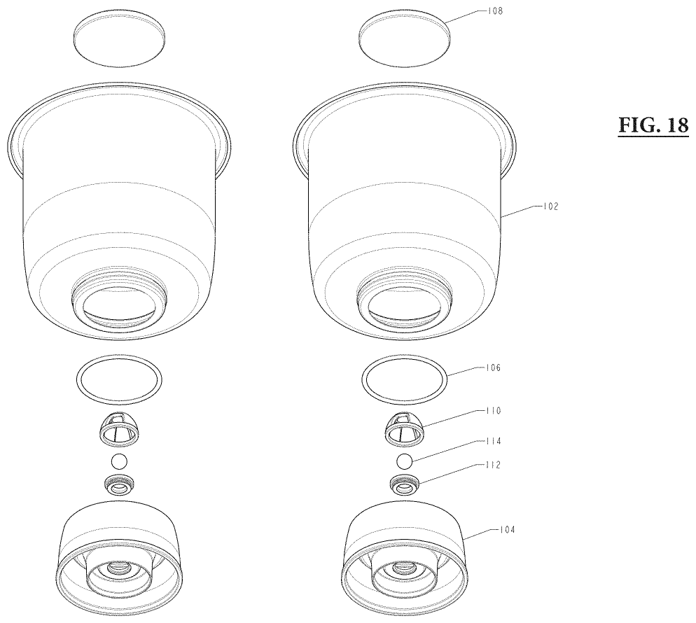

FIG. 11 is a first exploded cross sectional view of the extraction system taken along the line A-A in FIG. 12. Similar views are provided in FIGS. 13-16. FIG. 17 is an isometric exploded view showing each of the components 102-114 isometrically. FIG. 18 is a bottom isometric exploded view of the extraction system shown in duplicate, again showing relative placement and alignment of the components.

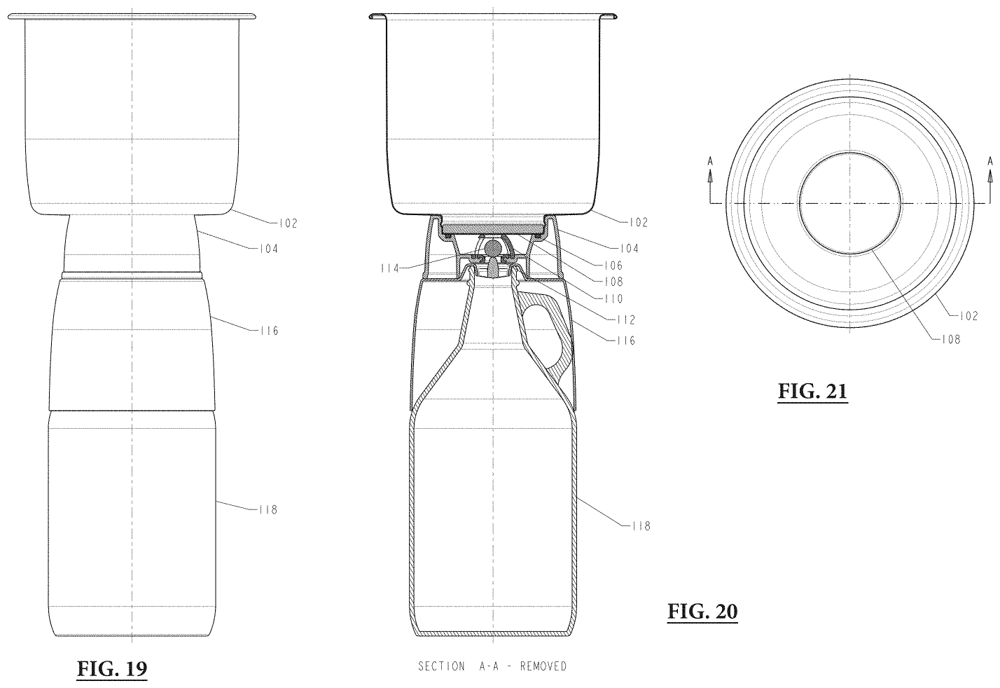

In further accordance with the disclosure, FIG. 19 is a side view of the extraction system mounted on top of a container 118, such as a growler, for capturing infused extract exiting from the extraction system. A funnel shaped skirt 116 can be removably attached to the container or growler 118. Skirt 116 is annularly shaped, having a circular peripheral lower edge that fits around the container and rests on the container. Component also provides an upper surface for supporting the combination of base 104, container 102, and components 106-114. Skirt 116 defines an opening at a central upper portion thereof with a raised surface, or protuberance or poker that extends upwardly far enough to push ball valve body 114 (e.g., upwardly in the illustrated embodiment) and out of physical contact with seal 112, thus permitting liquid within container 102 to be filtered by filter 108, and to drip down into container 118. It will be appreciated that alternative structures as set forth above can be applied to this embodiment concerning shape, configuration, valve operation, and the like.

FIG. 20 is a first cross sectional view of the arrangement of FIG. 19 taken along the cross sectional line A-A illustrated in FIG. 21. FIG. 20 clearly shows relative placement and alignment of component, or skirt, 116, with respect to container 118, base 104 and valve body 114. If desired and as mentioned above, an elastic or compliant member (e.g, compression spring (not shown)) can be situated between ball valve body 114 and the lower face of the upper portion of frame 110 to help keep the valve body 114 in the seal 112.

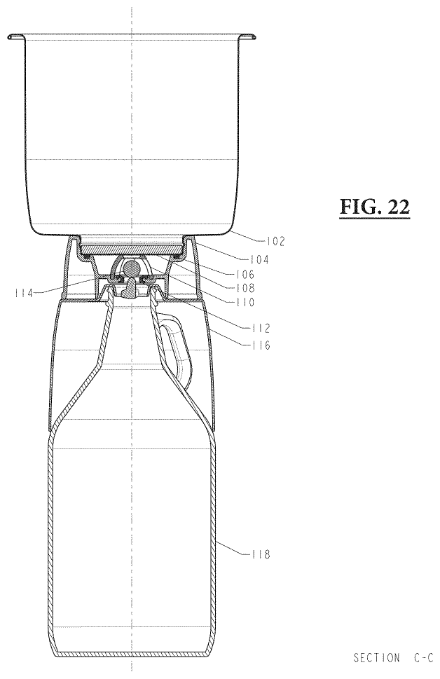

FIG. 22 is a second cross sectional view of the arrangement of FIG. 19 that is angularly rotated with respect to the view in FIG. 20 along the line C-C illustrated in FIG. 4. This similarly shows a different slice of the framework 110, and shows ball 114 being upwardly displaced to permit liquid to flow out of container 102 into container 118.

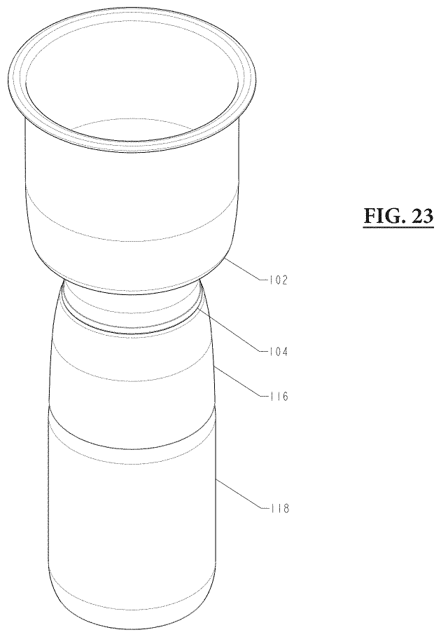

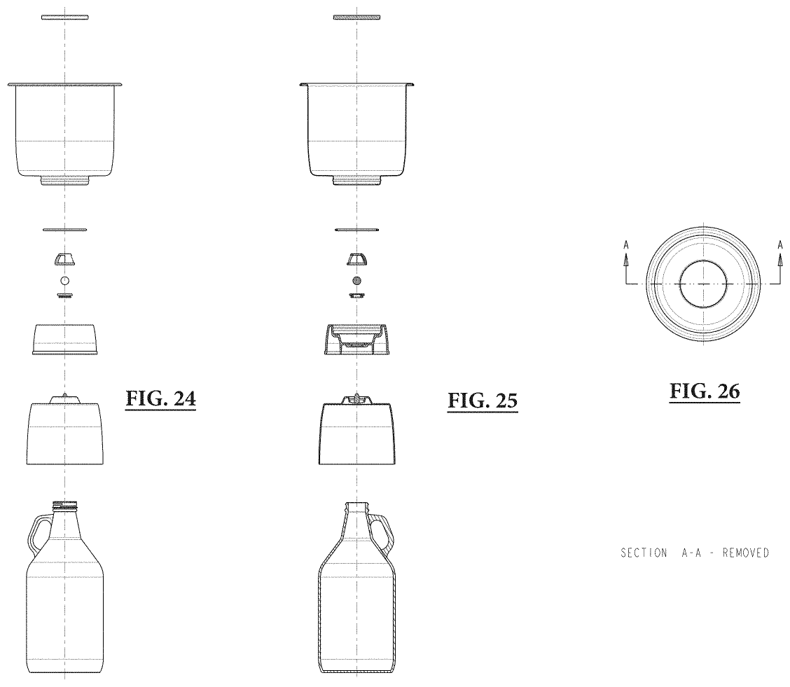

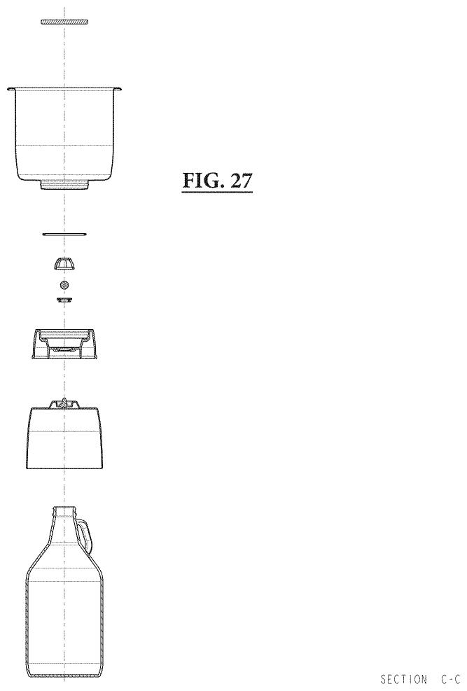

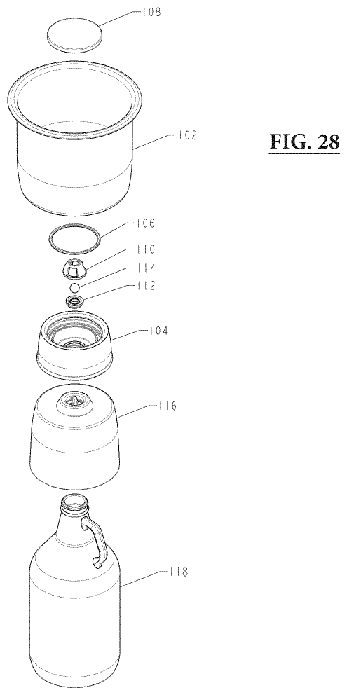

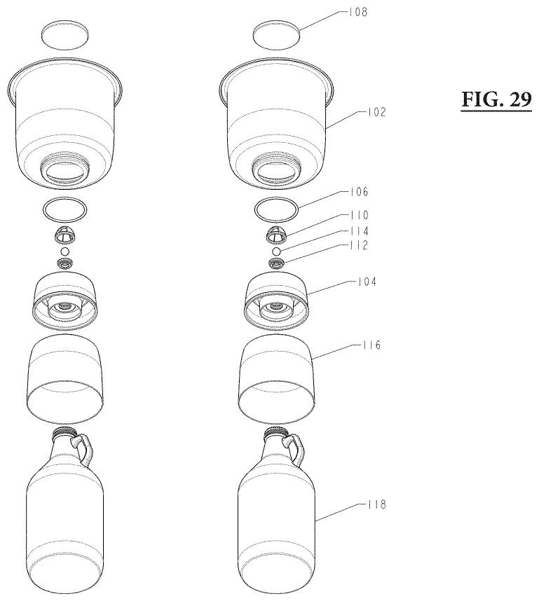

FIG. 23 is an isometric view of the arrangement of FIG. 19 showing relative placement of components. FIG. 24 is a side exploded view of the arrangement of FIG. 19, FIG. 25 is a cross-sectional exploded view taken along line A-A illustrated in FIG. 26. FIG. 27 is a cross-sectional exploded view taken along line C-C illustrated in FIG. 4. FIG. 28 is a top exploded isometric view of the arrangement of FIG. 19. FIG. 29 shows two side by side bottom exploded views of the arrangement of FIG. 19.

In some embodiments, in use, container 102 and base 104 can be maintained as an assembly that is dismounted from skirt 116 and container 118 during brewing. A mixture, for example, of coffee and water can be placed in container 102 and left to steep for an extended period of time (e.g., overnight). When sufficient steeping has occurred, the container and base 102, 104, can be transferred on top of skirt 116 on top of container 118, a suitably configured stand, or other vessel to transfer the infused extract into the container 118. Alternatively, if a valve is used that can be activated, for example, by twisting a handle, the container and base can be placed on a stand and a container placed underneath it, and the valve can be actuated to selectively permit flow of liquid into the container.

As alluded to above, in an alternative embodiment, skirt 116 can be replaced by a stand that suspends container 102/104 over a separate container. A poker or other protuberance in the stand can displace the valve body 114 upwardly permitting liquid to flow out. In other embodiments, a manual valve that is actuated controllably and manually, such as by a slide or a switch, can be used instead of valve body 114. In other embodiments, the manual valve can be switched on and off, to fill a number of smaller containers, placed in time series, under container 102/104.

In a further embodiment, a controllable electric valve can be used that is opened by actuation of a solenoid controlled by a controller. The controller can be electronic and have a microprocessor or other control system, such as a mechanical or electromechanical system. The control system can be configured to open the valve in response to (i) the passage of a predetermined time (e.g., as measured by an electronic or mechanical timer), (ii) the achievement of a particular temperature of the infused extract, or a relative temperature of the infused extract, (iii) the presence or absence of the receiving container, or combinations thereof. If desired, the control system can be configured with communications circuitry for communicating electronically with a personal electronic device of a user, and provide data to the user such as brewing time and other parameters, and permit the user to open the valve remotely.

In a further embodiment, the valve or dispenser of the system can be actuated by the application of positive or negative pressure in the reservoir of the system. For example, the valve can include a membrane made from a compliant material having one or more slits that is configured to deflect upon the application of positive or negative pressure. The positive or negative pressure can be applied by a user, or can be applied automatically, for example, by the contents of the reservoir.

In a further embodiment, the container and base 104 can be configured to be received by an opening of a growler, wherein stability of the container 102 can be assured at least in part by a mechanical connection between an outer surface of a downwardly extending conduit of the base, and an inner surface of a neck of the growler, or other container. Any type of valve, including but not limited to those described herein can be used for any of the disclosed embodiments, including but not limited to those embodiments having receiving containers that self-center under the valve.

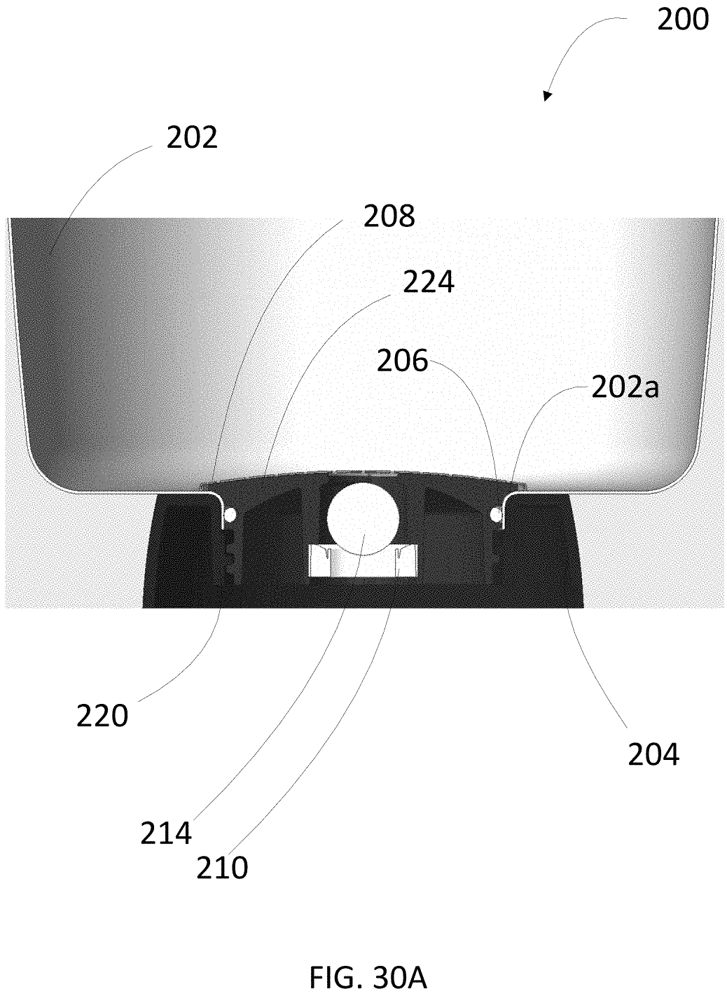

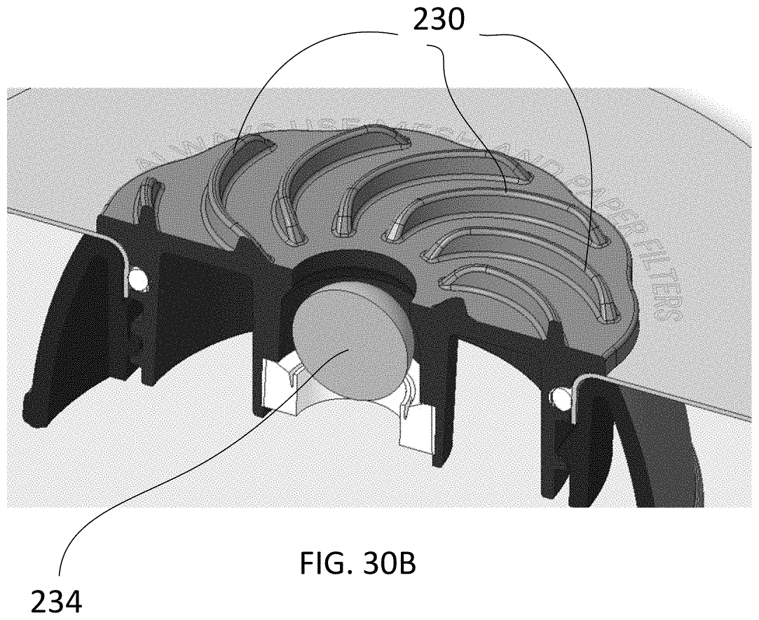

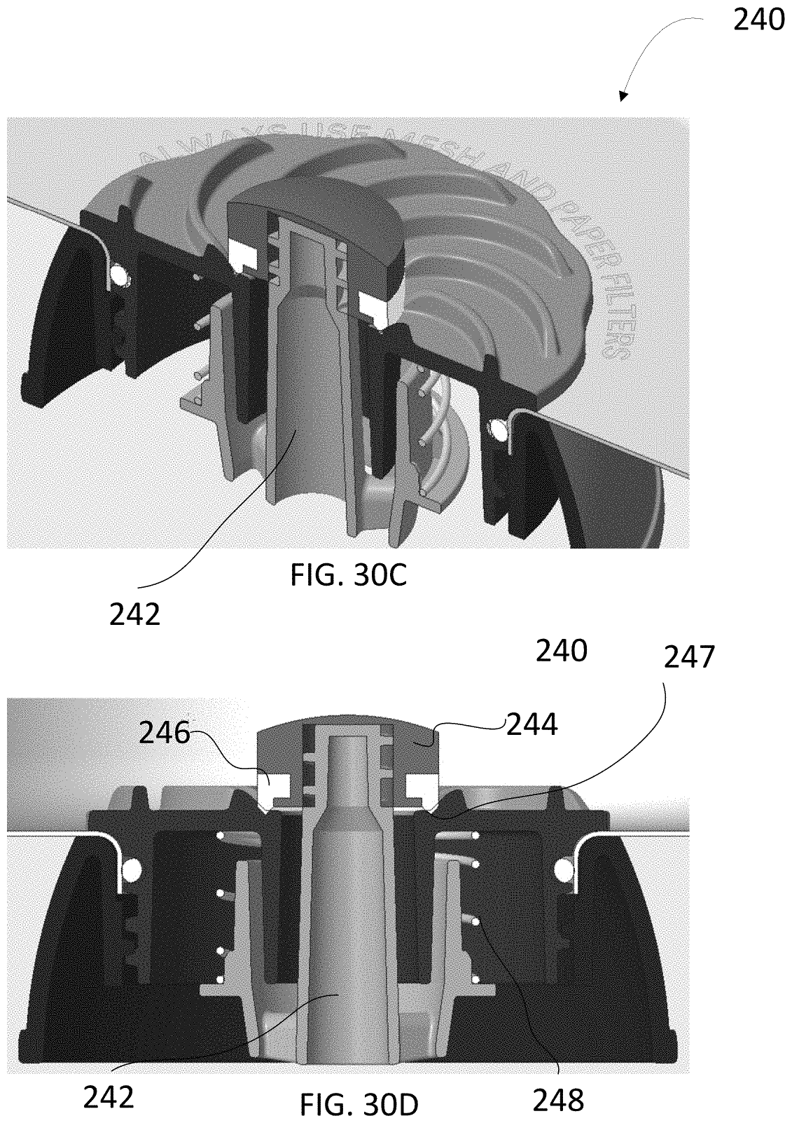

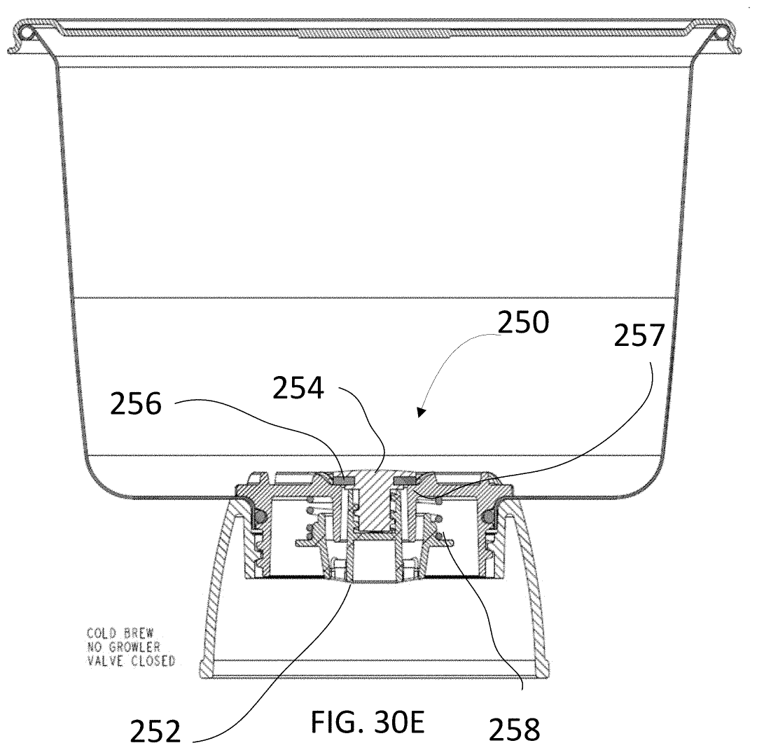

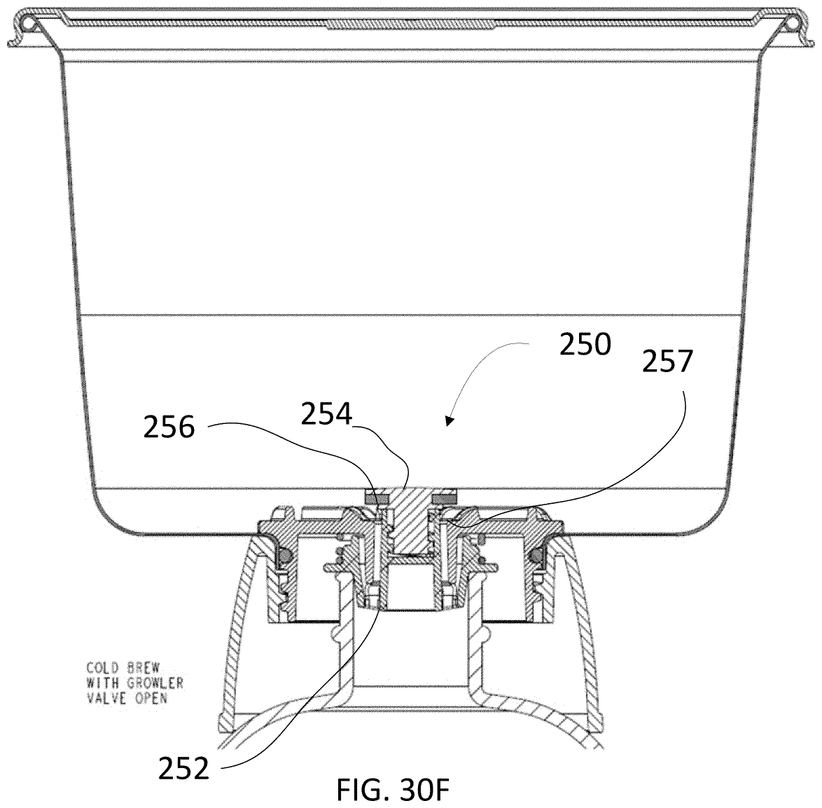

An illustration of a variation of a brewing device 200 in accordance with the disclosure is depicted in FIG. 30A. FIG. 30A presents a central vertical cross section of an illustrative brewing device that includes a container portion 202 that is connected to a base portion 204 by way of a threaded connection. As illustrated, a central housing portion 224 having threads disposed on an exterior surface thereof threadably mates with corresponding threads formed in an inner surface of base portion 204. To assemble the device 200, container portion 202 is inserted into an upper portion of base portion 204. Central housing portion 224 is then threaded into base portion 204, capturing a lower peripheral lip of container 202 between the base portion 204 and the central housing portion 224.

In this specific illustration, container 202 is defined by a slightly tapered vertical wall that tapers radially inward (with respect to a vertical central axis of device 200) from the top toward the bottom. At a bottom outer portion of the container 202, the peripheral wall of the container bends radially inwardly and traverses a horizontal direction toward the vertical central axis of device. Before reaching the central axis, the peripheral wall traverses a downward bend to define a lower peripheral edge, or lip that surrounds a bottom opening. The lower peripheral lip is received in a complementary perimeter recess formed in an upper portion of the base portion 204. As illustrated, a peripheral seal 206 is provided that is received about an upper circumferential extend of the central housing portion 224 that is situated above the threads formed around the central housing portion and below a perimeter flange that traverses the outer perimeter of an upper end of the central housing portion 224.

As illustrated, central housing portion 224 also includes an upper perforated layer 208 that performs a filtering function for infused extract passing through the layer 208. Layer 208 can be a layer of plastic or metal, for example, with a plurality of openings formed through it in any desired shape or arrangement. Layer 208 is preferably a removable cap portion that fits around the peripheral edge of the central housing portion 224 to facilitate disassembly and cleaning. If desired, a removable filter can be placed inside of container 202 that generally conforms to its geometry in addition to, or in lieu of, layer 208.

An illustrative valve is provided that is similar in some respects to the embodiment of FIG. 2A in that it includes a spherical valve body 214 that rests on a ring-shaped valve seat 210 that is received in a central channel defined in a lower surface of central housing portion 224. As with the embodiment of FIG. 2A, the illustrated valve opens when the valve body 214 is pushed out of the way, such as from underneath. Valve body 214 can be removed, for example, by removing the perforated cover 208. It will be appreciated that any desired valve can be used in place of the depicted arrangement as with the embodiment of FIG. 2A. Moreover, it will be appreciated that the shape, size dimensions, and materials of container 200 can be varied as desired as with the embodiment of FIG. 2A.

FIG. 30B presents a perspective cross section of a variation of the embodiment of FIG. 30A. In this illustration, perforated layer 208 is replaced with a cap that is illustrated as being imperforate, and includes a plurality of raised ridges 230 that travel at least partially along a radial direction. As illustrated, the ridges 230 are of a curvilinear shape, but can be straight, serpentine shaped or the like. If desired, rather than linear ridges, bosses, or bumps of the same or varying heights can be used. The ridges 230 and/or bosses are preferably used to suspend a filter paper (e.g., 330 in FIG. 31A) with infusible material and liquid therein, and to provide one or more pathways to flow toward the valve 234 disposed in the center of the embodiment. As with the embodiment of FIG. 30A, the assembly can be attached by mechanical threads, for example, and can be disassembled easily for cleaning.

FIGS. 30C and 30D are cross-sectional isometric and cross sectional views of a further embodiment of a valve for an infusing container in accordance with the present disclosure. This embodiment is similar in general appearance to that of FIG. 30B in that it includes curved radially oriented ridges. But, this embodiment includes a piston valve 240 that in turn includes a vertically displaceable valve body, or piston, that includes a lower portion 242 that is mated to an upper portion 244 that is disposed within the infusing container via a mechanical engagement, such as a threaded engagement, snap fit, a separate fastener, or the like. Upper portion 244 is disposed above a circumferential seal 246 that is received in a valve seat 247. Valve 240 is biased in a closed position by an elastic member or spring, such as a compression spring 248. In operation, a protuberance or poker from a container or adaptor can push the valve body upwardly to initiate the flow of infused extract out of the reservoir of the infusing container (e.g., 102, etc.). Alternatively, the mouth of a container, such as a growler, can urge upwardly against the lower portion 242 as illustrated with respect to the embodiment of FIG. 30F. Moreover, as illustrated the lower portion 242 of the valve body defines a circumferential channel therein for receiving a similarly shaped opening of a bottle or other container. Thus, for example, by pushing upwardly on the valve body with a receiving container, the valve can be opened, permitting the container to be opened. If desired, a separate vent (not shown) can be provided in any embodiment herein to facilitate the passage of gas that is being displaced from the receiving container.

FIG. 30E is a cross sectional view of another embodiment of a brewing apparatus in accordance with the present disclosure with a valve in a closed condition. FIG. 30F is a cross sectional view of the embodiment of the brewing apparatus of FIG. 30E with the valve in an open condition. The components of the brewing apparatus in these figures are similar in some respects to the embodiment of FIGS. 30C and 30D. This embodiment also includes a piston valve 250 that in turn includes a vertically displaceable valve body, or piston, that includes a lower portion 252 that is mated to an upper portion 254 that is disposed within the infusing container via a mechanical engagement, such as a threaded engagement, snap fit, a separate fastener, or the like. In this embodiment, threads defined on an exterior portion of the upper portion 254 mate with internal threads defined in lower portion 252. Upper portion 254 is disposed above a circumferential seal 256 that is received in a valve seat 257. This configuration of a valve is lower in profile with respect to the previous embodiment. Valve 250 is biased in a closed position by an elastic member or spring, such as a compression spring 258. In operation, and with respect to FIG. 30F, the open top of a container surrounds a downwardly depending portion of valve lower portion 252 and urges against a flattened flange that is located at an outer radial location of lower portion 252. Thus, for example, by pushing upwardly on the valve body with a receiving container, the valve can be opened, permitting the container to be opened. If desired, a separate vent (not shown) can be provided in any embodiment herein to facilitate the passage of gas that is being displaced from the receiving container.

FIG. 31A illustrates a schematic, cross sectional view of a further embodiment of a brewing apparatus 300 and container 340 for receiving infused extract. This embodiment includes a container 302 similar in configuration to the embodiments of FIGS. 1 and 30A, and includes a base portion 304 that can be integral with or detachable from the container 302. For example, embodiment 300 can be made from injection molded polymer and the like. A screen or perforated layer 308 can be provided similar to the embodiment of FIG. 30A, and, if desired, a removable/disposable filter 330 can also be used that generally conforms to the inner surface of the container 302. Any sort of desired valve 314 can be used, including but not limited to those discussed elsewhere herein. Moreover, it will further be appreciated that an actual valve need not be provided in any of the embodiments illustrated herein, and other mechanisms can be used, such as a filter that permits a very slow flow therethrough, a dissolving plug or stopper (made from comestible material, such as a material including a flavorant or other additive), and the like.

Embodiment 300 is particularly configured to rest on top of a bottle with a flat top that is generally known in the art. It is particularly suitable for receiving a container on top of it because it has a flat top. Device 300 is preferably configured to self-center on top of the container 340. Base portion 304 can include one or more integral fins distributed circumferentially around the base of embodiment 300, or may take the form of a cylindrical or other peripheral wall.

As illustrated, a downwardly depending spout of container 300 is illustrated as being received by a neck portion, spout, or “finish” portion of the container 340 at an interface 324. The spout may simply rest within the opening of the container at the interface location. If desired, the spout may achieve an interference fit with an inner wall of the spout of the container, and/or with an outer part of the container at the interface 324. If desired, the spout may be configured to threadably mate with threads (not shown) around the periphery of the spout of the container 340. In this and other embodiments herein, forming a threadable engagement between the container 340 and the device 300 can act to open the valve 314. In further embodiments, physical contact or engagement of other portions of the receiving container (e.g., bottom, side, neck, shoulder, and the like) and the brewing apparatus can also actuate the valve or other dispensing mechanism.

FIG. 31B presents a further embodiment of an infusing system 350 in accordance with the disclosure. This embodiment is similar to that of FIG. 31A, but is specifically configured to seat on top of a receiving container 352 (e.g, growler, jar, etc.) that has a curved top. As can be seen, one or more projections extend downwardly from the infusing container that match the shape of the container. While the shape is shown as being static, in another embodiment, the support that touches and rests on the infusing container can be dynamic, and be formed from a deformable material. Alternatively, the supports, instead of curved, can be stepped such that the support contacts the receiving container at point locations. Alternatively, rather than a steady curve, a compound curve can be used having different portions that can fit to containers of different curvatures and/or diameters.

FIG. 31C presents still another embodiment of an infusing system 370 in accordance with the disclosure. While many of the disclosed embodiments provide infusing containers (e.g., 102) that are configured to self-align with a receiving container or other structure by aligning with a top surface or bore of a receiving container. The bore of the receiving container can be between about, for example, 5 mm and 250 mm, and any increment therebetween of one millimeter. Embodiment 370 presents a design wherein the infusing container and receiving container align using one or more additional alignment techniques. While alignment exists in the filling neck region of the container by a downwardly depending portion of the infusing container extending down into the neck of the container, this need not be used at all, and liquid from the infusing container can simply pour into the receiving container. Instead, alignment can alternatively be achieved by aligning one or more of an outer side wall of the receiving container with an inwardly facing surface of the infusing container, such as a side wall or support pillar 372. This can be one or more pillars, or partial or full wall sections, wherein alignment is achieved by sliding the assembly 370 downward around the container 375. The relative radial alignment can then be achieved, for example, by simply having straight walls, or walls having a taper that have an inwardly facing vertical surface that tapers along a radially inward direction along the pillar or wall 372 along an upward direction, resulting in a “funneling” effect that directs the container 375 into alignment.

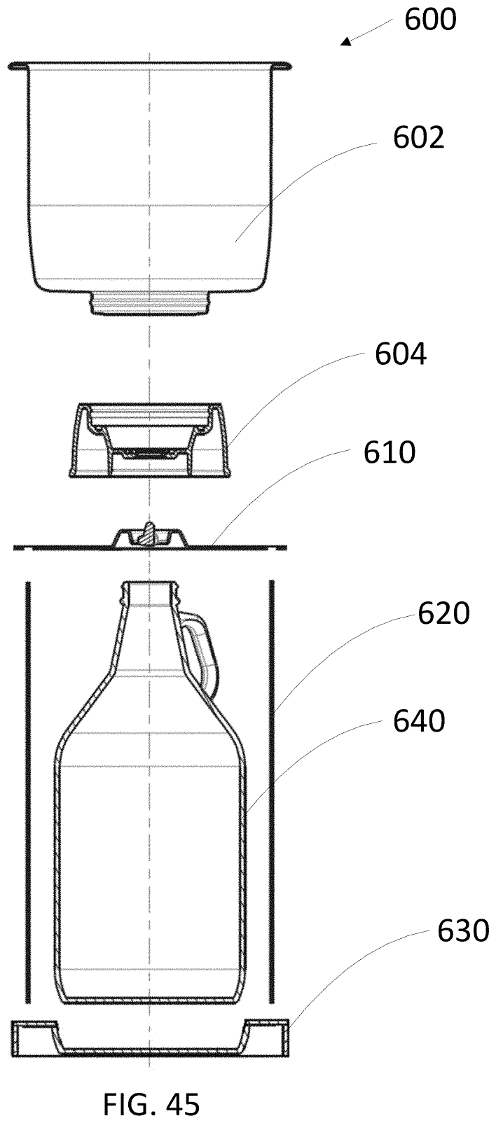

Additionally or alternatively, a base portion 378 of the system 370 can be aligned with a bottom face of the container 375, such as by registering with the overall shape of the bottom of the container 375 (e.g., FIG. 45), or by aligning with an indentation and/or a raised surface formed on the bottom surface of the container 375. For example, an indented surface can be formed on the bottom of the container 375, and a raised boss 376 can be provided on a bottom plate of the apparatus 370 to help obtain registration between the container 375 and the apparatus 370. While not depicted, system 370, or any other system herein, can be configured to achieve alignment with a handle of a receiving container.

FIG. 31D presents still another embodiment of an infusing system 390 in accordance with the disclosure. This embodiment is illustrated as using a frangible, preferably disposable, membrane 394 that is breached by a filter element 392 provided in the form of a perforated cone. In this embodiment, the membrane 394 can be a filter paper, or another material that is not a filter medium. Liquid(s) and infusible material are disposed within the volume surrounded by the membrane 394, and liquid dispensing can be achieved by lowering system 390 onto a protuberance or filter element 392 that pierces the membrane, permitting the liquid to flow out. In so doing, a lower face or strut or fin 398 of the system 390 can be configured to rest on an upwardly facing surface 396 of an adaptor that rests on top of the receiving container.

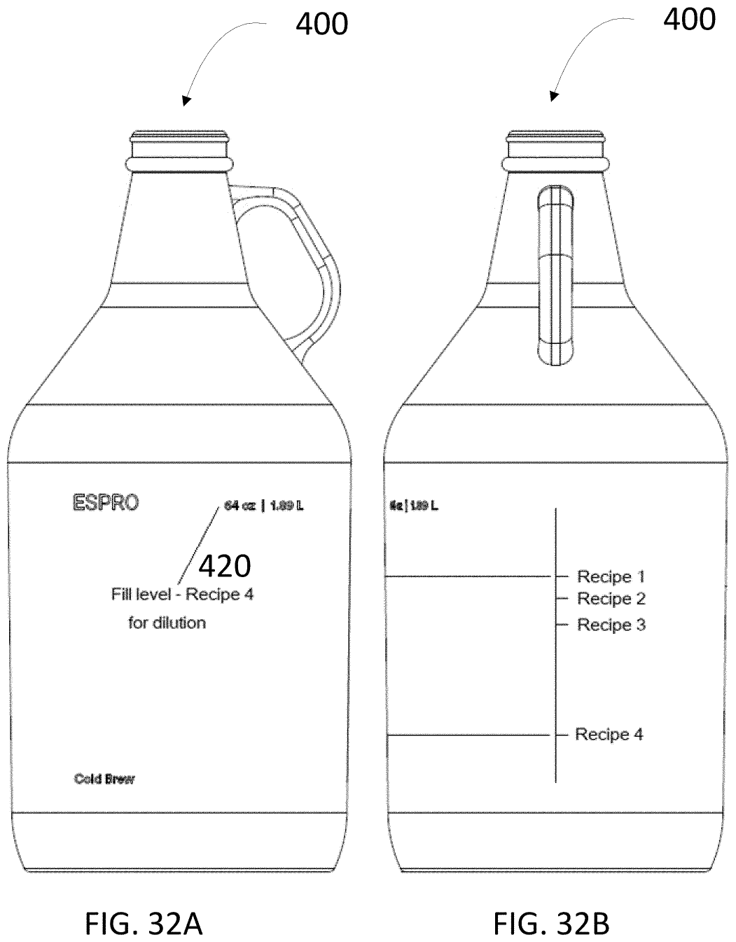

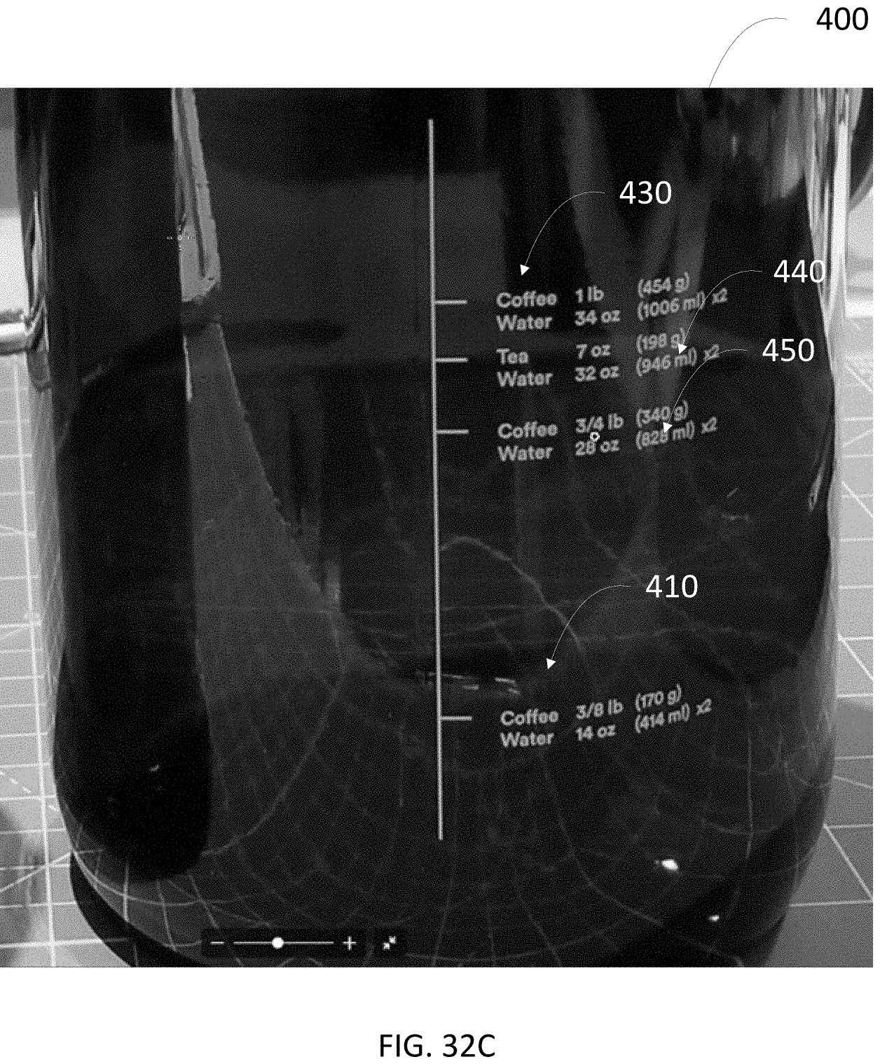

FIGS. 32A-C illustrate a side view of a container 400 for receiving infused extract from a brewing device, such as that set forth herein. As illustrated, the container includes indicia 410 formed on a sidewall thereof, wherein the indicia includes a recipe, or instructions, for preparing cold brew coffee of a desired strength. As an illustrative example, the lowest positioned recipe on the sidewall depicted in FIG. 32C includes a horizontal fill line for filling water. In this case, the indicia provides instructions to fill the container twice to the specified fill line and to use this amount of water in the container (e.g, 102) in combination with ⅜ lb., or about 170 g of coffee grounds. This mixture will yield an amount of concentrate that, when dispensed back into the container 400 is at the correct concentration to be diluted up to the 64 ounce mark 420 near the top of the growler. At that dilution, the coffee is ready for drinking. Thus, in the aforementioned example, the indicia on the side of the bottle provided a first fill line for measuring water to prepare an infused extract, and also specified the amount of infusible material (in this example, coffee) to mix with the water in the container. After brewing, the bottle provided a second indicia for diluting the concentrated infused extract to dilute it to a suitable concentration for drinking. Implicit in the instructions/indicia is that the amount of water expected to remain in the grounds within the container has been factored into the recipe. Also present on the container are additional recipes 430, 440, for making increasing amounts of concentrated infused extract. However, since those recipes create larger amounts of concentrate, a second corresponding fill line is not provided on the bottle for dilution since dilution of the larger amount of extract for those recipes would exceed the volume of the container 400. As with the first recipes, though, the second and third recipes provide for an appropriate amount of water that accounts for the water that remains behind in the coffee grounds in the container (e.g., 102).

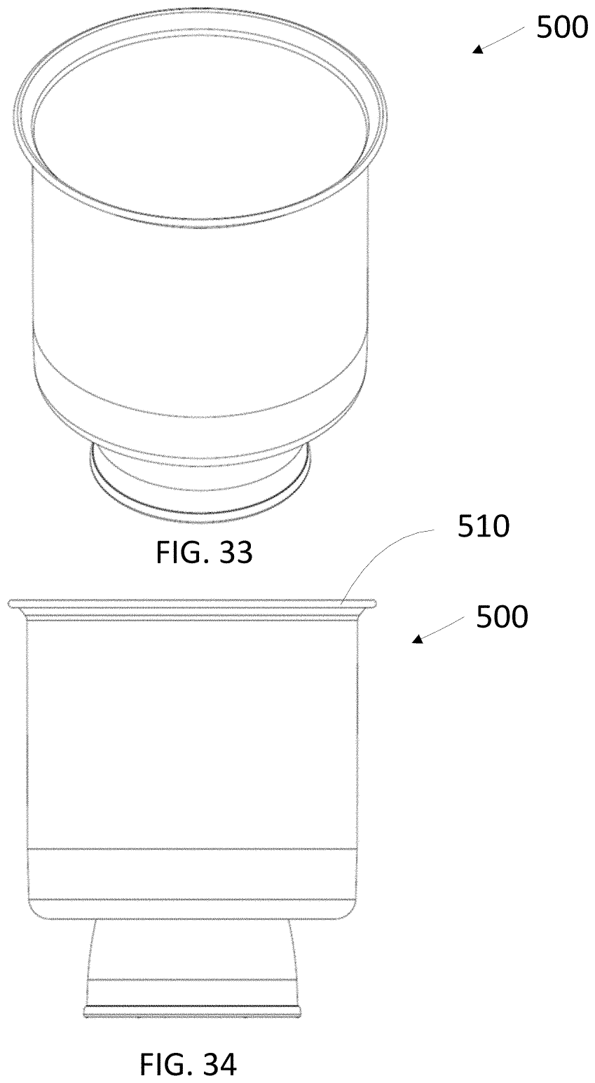

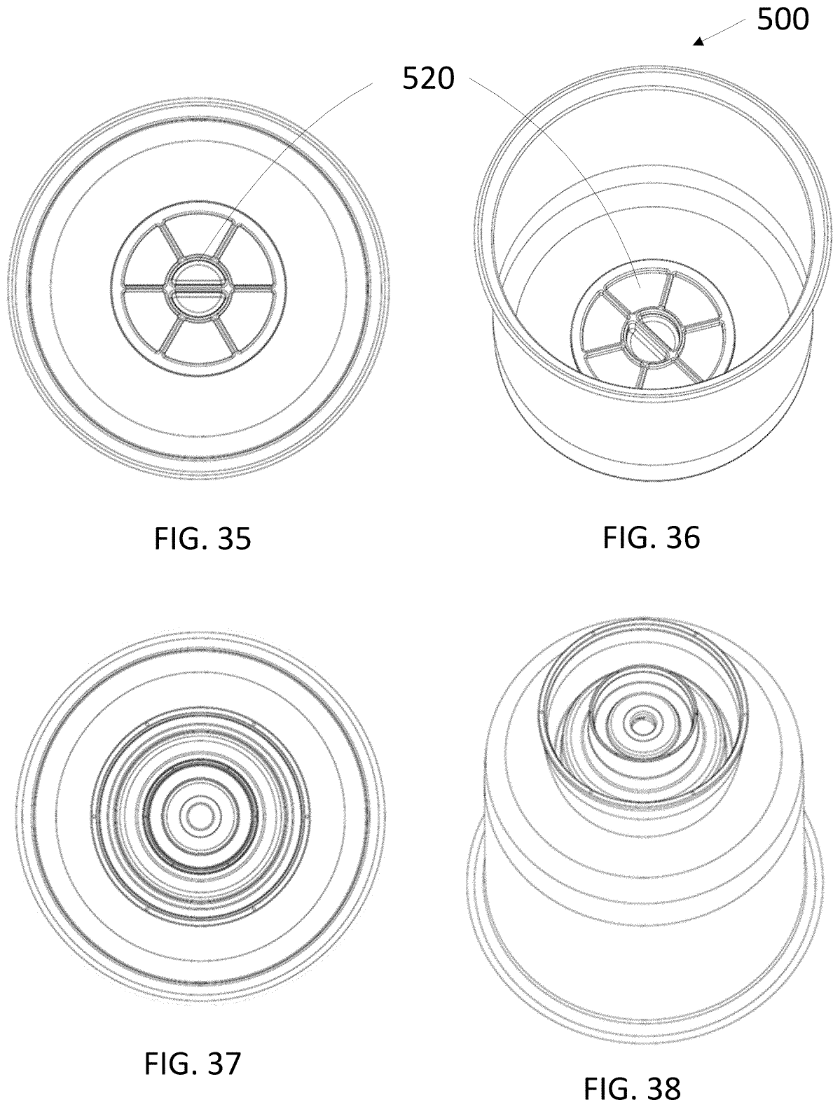

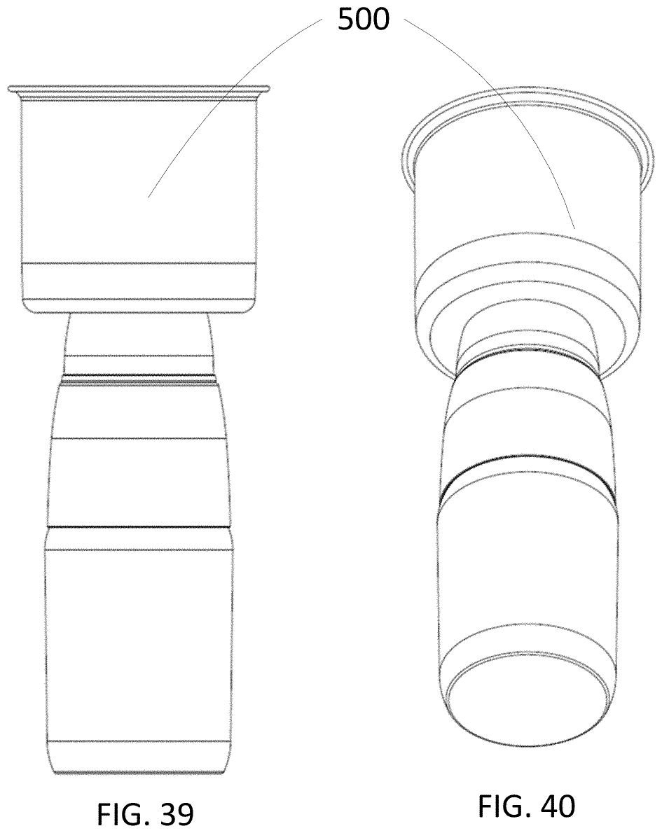

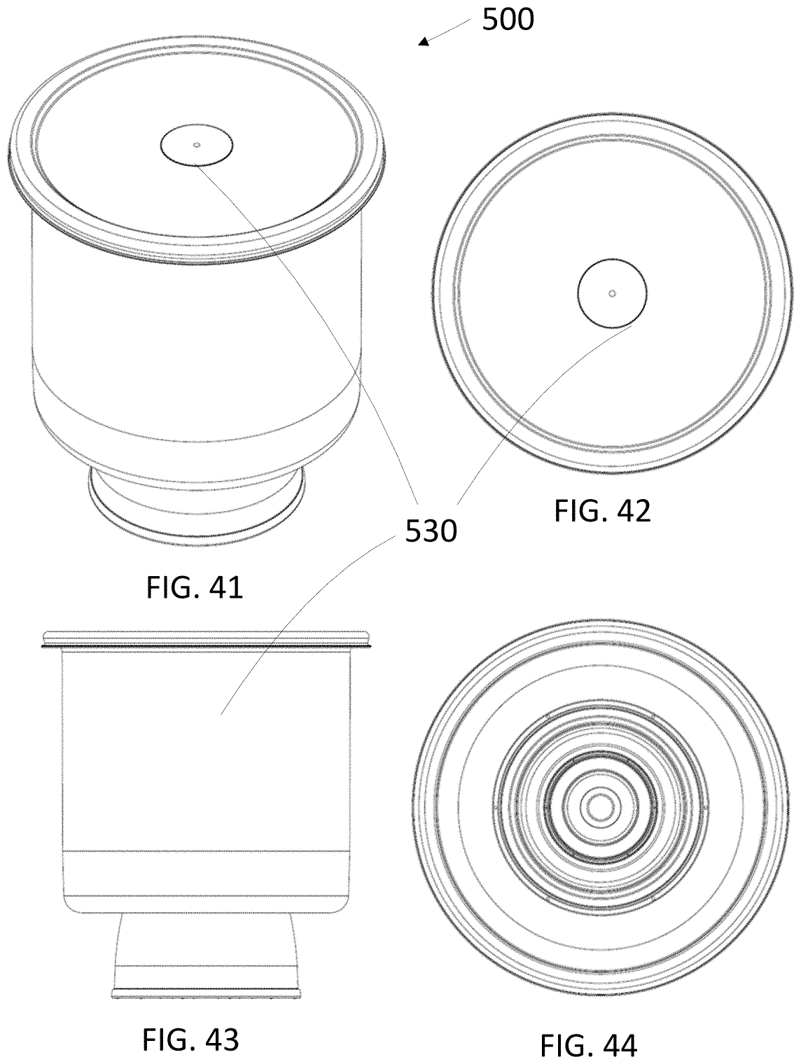

FIGS. 33-44 illustrate still further embodiments in accordance with the disclosure. FIGS. 33 and 34 illustrate isometric and side plan views, respectively, of a further embodiment of a brewer system 500 in accordance with the present disclosure. The embodiment of FIGS. 33-44 is very similar to the embodiment of FIGS. 1-29, with some differences. First, the upper peripheral ridge 510 of the container is shaped differently so as to receive a removable lid 530 (FIG. 41) to close off the opening in the upper end of the brewing container. The brewing container itself also has a slightly different shape. Moreover, a removable retainer 520 (FIGS. 35-36) is disposed within the bottom of the brewing container to hold a filter mesh (not shown) in place. However, it will be appreciated that any of the filtering approaches disclosed elsewhere herein can be used in association with embodiment 500. Other visible aspects of system 500 are substantially the same as the system of FIGS. 1-29.

FIG. 45 presents a further variant of the embodiment of FIGS. 1-29, including a system 600 that includes a brewing container 602 (that can be configured to be provided with a lid as the embodiment of FIGS. 33-44, if desired), and a base 604 that can be attached to a bottom of the brewing container as discussed elsewhere herein. While a valve and filter are optional, the embodiment of FIG. 45 contemplates a valve and filter similar to that in the embodiment of FIGS. 1-29, and any other valve as set forth herein can be used.

With continuing reference to FIG. 45, base 604 rests on a stand that is in turn composed of an upper framework, 610, one or more vertical supports 620, such as one or more walls, and a base portion 630. As illustrated, base portion 630 defines a dish shaped receptacle that is sized and shaped to receive a bottom of container 640. Preferably, the receptacle of base portion 630 is configured to center the container 640 underneath the brewing apparatus. The upper framework 610 of the stand includes one or more openings defined through its central region to permit the passage of infused extract from container 602. Upper framework 610 also illustrates an optional protuberance for actuating a valve disposed in a bottom of container 602 as discussed elsewhere herein to permit infused extract to flow into the container 640. The device illustrated in FIG. 45, or any other device disclosed herein, can have a stand, or other appropriate alignment bosses, fins or adaptors, as appropriate, (i) that aligns the growler under the spigot and/or valve or other output of the reservoir (“output”), (ii) that aligns said output with respect to the inside of the receiving container, the threads or finish or flange of the top of the reservoir, (iii) that aligns said output with the top, handle, outside of the top of the container before it tapers, the taper along the neck of the receiving container, the radius or transition between the taper of the neck and the outermost diameter of the bottle, the lower diameter between the base and the container wall, and the like.

It will be appreciated that a variety of alternatives in materials, construction techniques, configurations, shapes and the like can be made to any of the embodiments disclosed herein. For example, any feature discussed with respect to any embodiment of the infusing system, including but not limited to alignment structures and valves, may be suitably incorporated into any other embodiment of the infusing system. It will also be appreciated that the brewing reservoir of any disclosed embodiment can be configured so as to not actually touch the receiving container. Thus, while the present disclosure herein has been described with reference to particular preferred embodiments thereof, it is to be understood that these embodiments are merely illustrative of the principles and applications of the disclosure. Therefore, modifications may be made to these embodiments and other arrangements may be devised without departing from the spirit and scope of the disclosure.

What is claimed is:

1. An infusion apparatus for making an infused extract from at least one liquid and at least one infusible material, comprising:
an infusing container to receive at least one liquid and at least one infusible material to form an infused extract, the infusing container defining a drain orifice through a bottom wall thereof;
a displaceable valve body disposed in the drain orifice, the displaceable valve body being displaceable between an open position and a closed position, the displaceable valve body having a lower portion disposed underneath the infusing container including an upwardly extending stem that extends upwardly through the drain orifice into the infusing container; and
a seal coupled to the stem of the displaceable valve body to form a seal between the displaceable valve body and the infusing container when the displaceable valve body is in a closed position.

2. The infusion apparatus of claim 1, wherein the valve body is spring biased into a closed position by a spring.

3. The infusion apparatus of claim 2, wherein the spring is a compression spring disposed around the stem of the displaceable valve body, the compression spring having an upper end that urges against a lower face of the infusing container and a lower end that urges the valve stem in a downward direction.

4. The infusion apparatus of claim 3, wherein the lower end of the compression spring urges against a circumferential surface extending radially outwardly from the valve stem.

5. The infusion apparatus of claim 4, wherein the circumferential surface terminates in an annular region configured to be pushed upwardly by a circumferential lip of a receiving container that is coupled to the infusion apparatus.

6. The infusion apparatus of claim 5, wherein the lower end of the infusion apparatus defines a downwardly depending circumferential skirt to surround an upper end of the receiving container.

7. The infusion apparatus of claim 6, wherein the downwardly depending circumferential skirt defines a connection along a radially inwardly facing surface thereof to receive a threaded connection of the receiving container.

8. The infusion apparatus of claim 1, wherein the seal is circumferentially disposed around an upper end region of the stem.

9. The infusion apparatus of claim 8, wherein the seal resides at least partially within an annular groove formed around the valve stem.

10. The infusing container of claim 1, wherein the seal is received in a valve seat defined in the infusing container.

11. The infusing container of claim 1, wherein a lower inner surface of the infusing container includes a plurality of upwardly extending ridges that progress at least partially along a radially outward direction.
